(19) United States
(12) Patent Application Publication
(10) Pub. No.: US 2022/0250981 A1
(43) Pub. Date: Aug. 11, 2022

(54) CELLULOSE FIBRIL-ENHANCED REPAIR MORTARS

(71) Applicant: Performance BioFilaments Inc., Vancouver (CA)

(72) Inventors: Gurminder MINHAS, Burnaby (CA); Keith GOURLAY, Vancouver (CA); Nemkumar BANTHIA, Vancouver (CA); Obinna ONUAGULUCHI, Vancouver (CA)

(21) Appl. No.: 17/617,491

(22) PCT Filed: Mar. 11, 2020
(86) PCT No.: PCT/CA2020/050379

§ 371 Date: Dec. 8, 2021

Related U.S. Application Data
(60) Provisional application No. 62/878,244, filed on Jul. 24, 2019.

(51) Int. Cl. C04B 20/00; C04B 28/04

(52) U.S. Cl. CPC C04B 20/006; C04B 2103/46; C04B 28/04

(57) ABSTRACT

Repair mortar and methods of preparing repair mortar are provided. The repair mortar comprise a cement binder, fine aggregate and cellulose fibrils. In some embodiments, the cellulose fibrils are dispersed uniformly throughout the repair mortar. In some embodiments, the cellulose fibrils comprise nanofibrillated cellulose and/or microfibrillated cellulose. In some embodiments, the cellulose fibrils comprise an aspect ratio of between about 20 to about 500. The methods comprise mixing a cement binder, fine aggregate with water/chemical admixture to provide a cementitious material of good consistency, mixing cellulose fibrils with water to provide a cellulose fibril slurry, and mixing the cellulose fibril slurry with the workable cementitious material. In some embodiments, the cellulose fibrils are dispersed uniformly throughout the workable cementitious material.

### TECHNICAL FIELD

The present invention relates to repair mortars and specifically to cellulose fibril-enhanced repair mortars which provide enhanced interfacial bond strength between the repair mortar and a concrete substrate. This repair mortar also minimizes the corrosion of steel reinforcement bar embedded in a repaired concrete.

### BACKGROUND

Concrete, being of good compressive strength and relatively cheap, is one of the most used construction materials. Unfortunately, concrete is susceptible to cracking and degradation which weakens its structural integrity. Corrosion of steel rebar in reinforced concrete further affects the durability of these structures. The primary reason for corrosion is the high permeability of some concrete. Due to high permeability, water, oxygen, chloride, and other corroding substances penetrate the concrete matrix corroding embedded steel reinforcement bars.

To repair cracked or degraded concrete and/or to fill the honeycombs in concrete, a cement-based repair mortar is commonly used. Conventional cement-based repair mortars contain a binder (e.g. cement), a filler (e.g. sand, gravel, calcium carbonate, limestone aggregate, etc.), a bond enhancer (e.g. powdered polymers), and a hydrating agent (e.g. water). However, cement-based repair mortars have the disadvantage of cracking during initial curing and/or delamination caused by poor bonding at the interface between the repair mortar and the concrete. Statistics provided by Tilly and Jacobs (Tilly and Jacobs, Concrete Repairs, Performance in Service and Current Practice, HIS BRE Press, Bracknell, 2007) suggest that 20%, 55%, and 90% of cement-based patch repairs fail respectively within 5, 10, and 25 years. 80% of cement-based patch repair failures are traceable to delamination-, cracking-, and corrosion-related issues due to poor interfacial bond strength between the cement-based repair mortar and the concrete.

The interfacial bond strength at the mortar-concrete interface is influenced by at least two factors: (1) the surface condition of the concrete; and (2) the curing conditions of the cement-based mortar. Regarding the surface condition of the concrete, the concrete may be pre-treated. Pre-treatment typically involves one or more of scarring, roughening, and conditioning the surface of the concrete to be repaired before the repair mortar is applied. For example, the International Concrete Repair Institute (ICRI) recommends specific concrete surface roughness and provides preparation and evaluation techniques (ICRI Technical Guideline No. 310.2R-2013; Formerly Guidelines No. 03732: Selecting and Specifying Concrete Surface Preparation for Coatings, Sealers, and Polymer Overlays, ICRI 310.2R-2013, Minnesota, 2013). However, pre-treatment is typically time, energy, and cost intensive. Further, weather, urgency, and other external factors can influence pre-treatment.

Regarding curing conditions of the cement-based mortar, early-age volume changes and associated shrinkage stress generation may cause defects in the mortar during curing. During curing, the old dry concrete absorbs moisture from the cement-based mortar. This can cause a ‘false-set’ (i.e. a rapid hardening of the repair mortar), whereby the mortar dries to form a loose powder at the repair mortar/concrete interface (i.e. efflorescence). As a result, the strength of the interfacial bond between the cement-based repair mortar and the old concrete is impaired and delamination can occur.

Further, as a cement-based composite hardens, it shrinks. Therefore, a hardened (i.e. non-workable) cement-based mortar overlay typically has less volume relative to its freshly placed volume. At the early stage of mixing and placement, the cement-based composite is workable and is able to shrinks. However, as the cement-based composite cure and develop strength, its ability to shrink diminishes. A lack of moisture, especially in lower water-to-cement ratio cement-based composites, leads to autogenous shrinkage deformation and associated matrix cracking. Previous studies have shown that the inclusion of water-retaining porous materials such as fine light-weight aggregate (LWA) and superabsorbent polymers (SAP) in mixtures could reduce early-age autogenous deformation in cement composites (Jensen & Hansen, 2002; Bentz, 2007; Castro et al., 2011). However, given attributes such as wide availability, low density, high specific surface and hydrophilicity of nano and micro-sized cellulose fibers, they could also potentially serve as water-retaining and desorption agents in cement composites.

A major challenge to the introduction of cellulose fibers to a cement-based matrix is achieving uniform dispersion of the fibers throughout the matrix. Poor fiber dispersion and/or uneven fiber distribution in the cement-based matrix can reduce structural integrity and/or strength of the composite. Further, adding pulp fibers to cement-based composites generally detracts from the workability and placement time of the composite. Thus, higher water or superplasticizer content is often required to improve the workability and extend the placement time of the composite. The addition of extra water is typically avoided, because it makes cement-based materials more porous and weaker and generally reduces other performance properties of the cement composite (e.g. mechanical strength, bond strength, freeze and thaw properties, etc.).

Placement time refers to the amount of time it takes for a cement-based composite to be placed without considerable loss of workability. A cement-based composite with a significant loss of workability is not only difficult to compact and finish, but may also contribute to a poor bond between the composite and a cement-based substrate (e.g. concrete). A desirable placement time allows a user to spread a large area of mortar without the mortar losing consistency (i.e. workability) before it is finished.

Materials that act as good moisture reservoirs (i.e. by holding and releasing moisture internally during cement hydration) without negatively impacting the strength and durability of the cement-based composite include super-absorbent polymers (SAPs) and fine light-weight aggregates (LWAs). Unfortunately, these materials are not ideal because their use is not cost-effective in large scale applications. Also, because of their dimensional instability, SAPs can adversely affect the strength and elastic modulus of the cement-based composite.

Internal curing agents used to reduce autogenous shrinkage in cement-based composites are known. While the use of some of these internal curing agents gives rise to a high-strength cement-based composite, a high-strength cement-based composite does not necessarily serve as an effective, durable, and high performance cement composite. For example, high-strength cement composite is recognized to have excellent strength properties. However, when applied to a concrete substrate, high-strength cement mortars lack crack growth resilience at the mortar-concrete substrate interface. Accordingly, more brittle high-strength cement composite is not an effective repair material. In other words, the compressive strength of a cement-based material is not an indication of its performance-defining attribute. Thus, it is impossible to predict how a cement-based repair mortar will interact with a concrete substrate in forming an interface between the mortar and the substrate.

There is a general desire for cement-based repair mortars having enhanced overall performance properties, including interfacial bond strength at the cement-based repair mortar and the concrete substrate interface, and mitigation of corrosion of steel reinforcement bars in rehabilitated reinforced concrete structures. It is desirable that such repair mortars be comprised of sustainable, environmentally-friendly, and renewable materials.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention relates to a repair mortar which can provide enhanced interfacial bond strength between the repair mortar overlay and a concrete substrate. Compared to conventional mortars, the repair mortar described herein impart the final repair product with one or more of improved steel reinforcement corrosion resistance, reduced early-age deformation, and enhanced interfacial bond strength between the repair mortar overlay and a concrete substrate.

One aspect of the invention provides a repair mortar comprising a cement binder and cellulose fibrils.

In some embodiments, the cellulose fibrils are dispersed uniformly throughout the repair mortar.

In some embodiments, the cellulose fibrils comprise nanofibrillated cellulose and/or microfibrillated cellulose.

In some embodiments, the cellulose fibrils comprise an aspect ratio of between about 20 to about 500.

In some embodiments, the cellulose fibrils have a width of between about 20 nm to about 30 μm.

In some embodiments, the cellulose fibrils have a length of between about 1 μm to about 2,000 μm.

In some embodiments, the cellulose fibrils comprise between about 0.05 vol. % and about 5 vol. % of the repair mortar.

In some embodiments, the cellulose fibrils comprise about 0.1 vol. % of the repair mortar.

In some embodiments, the surface area of the cellulose fibrils is about 80 m²/g. In other embodiments the surface area of the cellulose fibrils may be between 60-100 m²/g.

In some embodiments, the water retention value (WRV) of the cellulose fibrils is between about 2 and about 5.

In some embodiments, the density of the cellulose fibrils is between about 1,300 kg/m³ and about 1,500 kg/m³.

In some embodiments, the viscosity of the cellulose fibrils is between about 1,000 mL/g and about 5,000 mL/g.

In some embodiments, the cement binder comprises one or more of aluminous cement, blast furnace cement, calcium aluminate cement, Type I Portland cement, Type IA Portland cement, Type Portland cement, Type IIA Portland cement, Type III Portland cement, Type IIIA Portland cement, Type IV Portland cement, Type V Portland cement, hydraulic cement (e.g. white cement, grey cement, blended hydraulic cement, Type IS-Portland blast-furnace slag cement, Type IP and Type P-Portland-pozzolan cement, and Type I (SM)-slag modified Portland cement), Type GU-blended hydraulic cement, Type HE-high-early-strength cement, Type MS-moderate sulfate resistant cement, Type HS-high sulfate resistant cement, Type MH-moderate heat of hydration cement, Type LH-low heat of hydration cement, Type K expansive cement, Type O expansive cement, Type M expansive cement, Type S expansive cement, regulated set cement, very high early strength cement, high iron cement, and oil-well cement.

In some embodiments, the cement binder comprises between about 20 vol. % to about 22 vol. % of the repair mortar.

In some embodiments, the repair mortar comprises a water to cement binder ratio of between about 0.2 to about 0.6.

In some embodiments, the cement binder comprises one or more of a filler, a chemical admixture, and a moisture-retaining agent.

In some embodiments, the filler comprises one or more of sand, calcium carbonate, limestone, crushed stone, and gravel.

In some embodiments, the filler comprises between about 45 vol. % and about 55 vol. % of the repair mortar.

In some embodiments, the chemical admixture comprises one or more of an air-entraining agent, retarding agent, accelerating agent, plasticizer, polymer, corrosion inhibitor, alkali-silica reactivity reduction agent, bonding agent, coloring agent, defoamer, odor-masking agent, and dry dispersing agent.

In some embodiments, the chemical admixture comprises between about 0.03 vol. % and about 0.3 vol. % of the repair mortar.

In some embodiments, the moisture-retaining agent comprises a co-polymer.

In some embodiments, the co-polymer comprises one or more of hydroxypropyl methylcellulose (HPMC), hydroxyethyl methylcellulose (HEMC), welan gums, and xanthan gums.

In some embodiments, the moisture-retaining agent comprises between about 0 vol. % and about 0.08 vol. % of the repair mortar.

Another aspect of the invention provides a method of preparing a repair mortar. The method comprises mixing a cement binder with water and chemical admixtures to provide a workable cementitious material, then adding a cellulose fibril slurry to the pre-mixed cementitious material. In some embodiments, mixing the cellulose fibril slurry with the workable cementitious material comprises dispersing the cellulose fibrils uniformly throughout the workable cementitious material.

Another aspect of the invention provides a method of preparing a repair mortar. The method comprises mixing a cement binder with water/chemical admixture to provide a workable cementitious material and mixing cellulose fibrils with the workable cementitious material. In some embodiments, mixing the cellulose fibrils with the workable cementitious material comprises dispersing the cellulose fibrils uniformly throughout the workable cementitious material.

Another aspect of the invention provides a method of preparing a repair mortar. The method comprises mixing a cement binder with cellulose fibrils to uniformly disperse the cellulose fibrils throughout the cement binder and mixing the cement binder and cellulose fibrils with water/chemical admixture to provide a repair mortar of very good consistency.

In some embodiments, the cellulose fibrils comprise nanofibrillated cellulose and/or microfibrillated cellulose.

In some embodiments, the cellulose fibrils comprise an aspect ratio of between about 20 to about 500.

In some embodiments, the cellulose fibrils have a width of between about 20 nm to about 30 μm.

In some embodiments, the cellulose fibrils have a length of between about 1 μm to about 2,000 μm.

In some embodiments, the cellulose fibrils comprise between about 0.05 vol. % and about 5 vol. % of the repair mortar.

In some embodiments, the cellulose fibrils comprise about 0.1 vol. % of the repair mortar.

In some embodiments, the surface area of the cellulose fibrils is about 80 m²/g. In other embodiments the surface area of the cellulose fibrils may be between 60-100 m² m²/g.

In some embodiments, the water retention value (WRV) of the cellulose fibrils is between about 2 and about 5.

In some embodiments, the density of the cellulose fibrils is between about 1,300 kg/m³ and about 1,500 kg/m³.

In some embodiments, the viscosity of the cellulose fibrils is between about 1,000 mL/g and about 5,000 mL/g.

In some embodiments, the cement binder comprises one or more of aluminous cement, blast furnace cement, calcium aluminate cement, Type I Portland cement, Type IA Portland cement, Type Portland cement, Type IIA Portland cement, Type III Portland cement, Type IIIA Portland cement, Type IV Portland cement, Type V Portland cement, hydraulic cement (e.g. white cement, grey cement, blended hydraulic cement, Type IS-Portland blast-furnace slag cement, Type IP and Type P-Portland-pozzolan cement, and Type I (SM)-slag modified Portland cement), Type GU-blended hydraulic cement, Type HE-high-early-strength cement, Type MS-moderate sulfate resistant cement, Type HS-high sulfate resistant cement, Type MH-moderate heat of hydration cement, Type LH-low heat of hydration cement, Type K expansive cement, Type O expansive cement, Type M expansive cement, Type S expansive cement, regulated set cement, very high early strength cement, high iron cement, and oil-well cement.

In some embodiments, the cement binder comprises between about 20 vol. % to about 22 vol. % of the repair mortar.

In some embodiments, the repair mortar comprises a water to cement binder ratio of between about 0.2 to about 0.6.

In some embodiments, the method further comprises mixing one or more of a filler, a chemical admixture, and a moisture-retaining agent with one or more of the cement binder and the workable cementitious material.

In some embodiments, the method further comprises mixing the one or more of a filler, a chemical admixture, and a moisture-retaining agent with a third liquid to provide a liquid mixture and adding the liquid mixture to one or more of the workable cementitious material and the cellulose fibril slurry.

In some embodiments, the filler comprises one or more of sand, calcium carbonate, limestone, crushed stone, and gravel.

In some embodiments, the filler comprises between about 45 vol. % and about 55 vol. % of the repair mortar.

In some embodiments, the chemical admixture comprises one or more of an air-entraining agent, retarding agent, accelerating agent, plasticizer, polymer, corrosion inhibitor, alkali-silica reactivity reduction agent, bonding agent, coloring agent, defoamer, odor-masking agent, and dry dispersing agent.

In some embodiments, the chemical admixture comprises between about 0.03 vol. % and about 0.3 vol. % of the repair mortar.

In some embodiments, the moisture-retaining agent comprises a co-polymer.

In some embodiments, the co-polymer comprises one or more of hydroxypropyl methylcellulose (HPMC), hydroxyethyl methylcellulose (HEMC), welan and xanthan gums.

In some embodiments, the moisture-retaining agent comprises between about 0 vol. % and about 0.08 vol. % of the repair mortar.

Another aspect of the invention provides a method of repairing a concrete substrate. The method comprises applying a repair mortar comprising a cement binder, fine aggregate and cellulose fibrils to the surface of the concrete substrate.

In some embodiments, the method further comprises pre-treating the surface of the concrete substrate.

Another aspect of the invention provides a use of a repair mortar comprising cement binder, fine aggregate and cellulose fibrils to repair a cracked concrete material and/or a degraded concrete material.

In some embodiments, the use of the repair mortar is to fill one or more voids or pores in a concrete material.

Another aspect of the invention provides a kit for preparing a repair mortar comprising a first container of cellulose fibrils and a second container of a fine aggregate and cement binder.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a chemical structure of a repeating unit (n) of cellulose.

FIG. 2 is a flow chart illustrating a method of preparing a repair mortar according to an example embodiment of the present invention.

FIG. 3 is a drawing of the area of hydration of a non-fibrillated pulp fiber (left) and cellulose fibrils (right).

FIG. 4 is a side elevation cross-sectional view of a cylinder comprised of a concrete substrate half-cylinder and a cement-based repair mortar half-cylinder.

FIG. 5 is a graph showing the results of slant shear tests conducted on cylinders comprised of a steel fiber-reinforced concrete substrate half-cylinder and a cement-based repair mortar half-cylinder with and without cellulose fibrils.

FIG. 6 is a graph showing the results of slant shear tests conducted on cylinders comprised of an unreinforced concrete substrate half-cylinder and a cement-based repair mortar half-cylinder with and without cellulose fibrils.

FIG. 7 is an image of the cylinders pure compression tested in FIG. 5.

FIG. 8 is an image of the cylinders pure compression tested in FIG. 6.

FIG. 9 is a graph showing the results of slant shear tests conducted on cylinders comprised of a steel-reinforced concrete substrate half-cylinder and a cement-based repair mortar half-cylinder with and without cellulose fibrils, wherein the surface of the concrete substrate is not pre-treated.

FIG. 10 is a graph showing the results of slant shear tests conducted on cylinders comprised of an unreinforced concrete substrate half-cylinder and a cement-based repair mortar half-cylinder with and without cellulose fibrils, wherein the surface of the concrete substrate is not pre-treated.

FIG. 11 is an image of the cylinders pure compression tested in FIG. 9.

FIG. 12 is an image of the cylinders pure compression tested in FIG. 10.

FIG. 13(a) is an image of CMF obtained from a multi-step refinement of bleached Kraft pulp at 30% consistency, with a micro-nano size distribution, with fibrils having a width of 80 nm-500 nm and a length of 100 μm-800 μm.

FIG. 13(b) is an image of 13 mm brass coated steel micro-fibers.

FIG. 13(c) is an image of 50 mm hook end steel fibers.

FIG. 14(a) is a cross-sectional view of corrosion test cylinder.

FIG. 14(b) is a top perspective view of the corrosion test cylinder shown in FIG. 14(a).

FIG. 15 is a schematic of the corrosion test set-up.

FIG. 16(a) is an image of corrosion test cylinder specimens.

FIG. 16(b) is an image of a split corrosion test cylinder specimen overlaid with a reference repair mortar.

FIG. 16(c) is an image of a split corrosion test cylinder specimen overlaid with a repair mortar according to an embodiment of the invention.

FIG. 17 is a graph showing corrosion current during corrosion tests conducted on test cylinders, wherein the concrete substrate is unreinforced.

FIG. 18 is a graph showing corrosion current during corrosion tests conducted on test cylinders, wherein the concrete substrate is steel fiber reinforced.

FIG. 19 is a graph showing time to crack during corrosion tests conducted on test cylinders.

FIG. 20 is a graph showing crack width over time during corrosion tests conducted on test cylinders.

FIG. 21 is a graph showing corrosion rate during corrosion tests conducted on test cylinders.

FIG. 22 is a graph showing pullout force before and after corrosion tests conducted on test cylinders.

FIG. 23(a) is a cross-sectional view of corrosion test prism.

FIG. 23(b) is a top perspective view of the corrosion test prism shown in FIG. 23(a).

FIG. 24(a) is an image of corrosion test prism specimens.

FIG. 24(b) is an image of a split corrosion test prism specimen overlaid with a reference repair mortar after a 15 V test

FIG. 24(c) is an image of a split corrosion test prism specimen overlayed with a repair mortar according to an embodiment of the invention after a 15 V test.

FIG. 24(d) is an image of a split corrosion test prism specimen overlaid with a reference repair mortar after a 25 V test

FIG. 24(e) is an image of a split corrosion test prism specimen overlayed with a repair mortar according to an embodiment of the invention after a 25 V test.

FIG. 25 is a graph showing corrosion current during corrosion tests conducted on test prisms at 7.5V.

FIG. 26 is a graph showing corrosion current during corrosion tests conducted on test prisms at 15 V.

FIG. 27 is a graph showing corrosion current during corrosion tests conducted on test prisms at 25 V.

FIG. 28 is a graph showing time to crack during corrosion tests conducted on test prisms.

FIG. 29 is a graph showing corrosion rate during corrosion tests conducted on test prisms.

FIG. 30 is a graph showing pullout force before and after corrosion tests conducted on test prisms.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Unless context dictates otherwise, “concrete” (as used herein) refers to a construction material made from a mixture of a binder (e.g. cement, etc.), one or more fillers (e.g. sand, calcium carbonate, limestone coarse aggregate, etc.), and a liquid (e.g. water, etc.). A moisture-retaining agent may be added to the mixture.

Unless context dictates otherwise, “concrete substrate” (as used herein) refers to a hardened and cured (i.e. non-workable) concrete to which a repair mortar is to be adhered.

Unless context dictates otherwise, “repair mortar” (as used herein) refers to a construction overlaid on a concrete substrate to repair a cracked and/or degraded concrete substrate and/or to fill the voids in a deteriorated concrete substrate.

Unless context dictates otherwise, “pulp fibers” (as used herein) refer to non-fibrillated cellulosic, hemicellulosic, and lignocellulosic fibers.

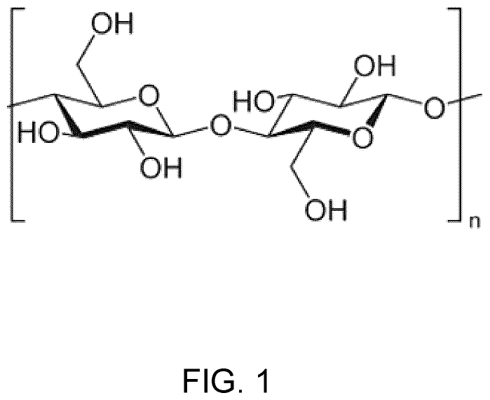

Unless context dictates otherwise, “cellulose” (as used herein) refers to a carbohydrate polymer comprising a chain of glucose units, all β-linked through the 1-4 positions. The structure of cellulose is shown in FIG. 1.

Unless context dictates otherwise, “cellulosic material” (as used herein) includes, but is not limited to, one or more of cellulose fibers, hemicellulose fibers, lignocellulose fibers, pulp fibers, kraft fibers, and thermomechanical pulp (TMP) fibers derived from one or more of hardwood, softwood, agricultural material (such as residues from agricultural crops including, but not limited to, one or more of wheat straw, barley straw, and corn stalks and fibrous materials including, but not limited to, cotton, hemp, flax, jute, and sisal), algal cellulose, marine plant cellulose, and derivatives thereof including, but not limited to, one or more of derivative pulp fibers (including, but not limited to, one or more of mechanical, thermomechanical, chemi-thermomechanical, chemical, recycled, and organosolv pulp).

Unless context dictates otherwise, “cellulose fibrils” or “cellulose fibril” or “CMF” (as used herein) refers to a cellulosic material that has been fibrillated, converting at least about 25% of the mass of the cellulosic material into nanoscale and/or microscale fibrillated regions. In certain embodiments cellulose fibrils include, but are not limited to, nanofibrillated cellulose (also known as cellulose nanofibrils) and/or microfibrillated cellulose (also known as cellulose microfibrils). In certain embodiments cellulose fibrils are comprised of a mixture of linear cellulose fibrils and branched cellulose fibrils. In certain embodiments cellulose fibrils are in a form wherein the fibrils are loose and individual. In such embodiments cellulose fibrils are dispersible and not aggregated/hornified/bonded together.

Unless context dictates otherwise, “workable” (as used herein) refers to a physical property of a freshly mixed concrete or a freshly mixed cement-based composite (e.g. cement-based repair mortar). Fresh concrete (or other fresh cement-based composite) is said to be workable if it can be easily mixed, placed, and/or compacted. Concrete (or other cement-based composite) is said to be non-workable if it cannot be mixed, placed and/or compacted without segregation (i.e. loss of homogeneity).

Unless context dictates otherwise, “hydrophobic” (as used herein) refers to a capacity to repel and/or fail to mix with water.

Unless context dictates otherwise, “hydrophilic” (as used herein) refers to capacity to attract and/or to mix with water.

Unless context dictates otherwise, “polymer” (as used herein) refers to a molecule, or macromolecule, formed by the polymerization of smaller molecules, called monomers, in a form that often, but not always, consists of a repeating structure.

Unless context dictates otherwise, “volume percent” (vol. %) (as used herein) refers to the ratio of the volume of one substance (v₁) to the total volume of a mixture (vₜₒₜ), as defined as:

Volume percent=v₁/vₜₒₜ×100%

With respect to repair mortars, vol. % refers to the ratio of the dry volume of one substance (v₁) to the total dry volume of a mixture (vₜₒₜ), as defined above.

Unless context dictates otherwise, “weight percent” (wt %) (as used herein) refers to the ratio of the mass of one substance (m₁) to the total mass of binder in a mixture (mₜₒₜ), as defined as:

$$Weight percent = \frac{{m}_{1}}{{m}_{t o t}} \times 100 \%$$

With respect to repair mortars, wt % refers to the ratio of the dry mass of one substance (m₁) to the total dry mass of binder in the mixture (mₜₒₜ), as defined above.

Unless context dictates otherwise, “surface area” (as used herein) refers to the measure of an exposed area of an object, expressed in square units.

Unless context dictates otherwise, “aspect ratio” (as used herein) refers to the ratio of the size of a cellulose fibril in the length and width dimensions, as defined as:

aspect ratio=length/width

Unless context dictates otherwise, “water retention value” (or “WRV”) (as used herein) refers to the measure of cellulose fibrils' ability to hold water. The WRV value equals the ratio of the liquid mass of the wet cellulose fibrils to the mass of the dry cellulose fibrils, as defined as:

$$WRV = \frac{{m}_{liquid}}{{m}_{dry}}$$

Unless context dictates otherwise, “slurry” (as used herein) refers to a semi-liquid mixture. The mixture may be colloidal.

Unless context dictates otherwise, “internal relative humidity” (as used herein) refers to the ratio of the amount of liquid and/or liquid vapour in repair mortar pores relative to the maximum amount of liquid and/or liquid vapour the repair mortar pores can hold at a given temperature and pressure.

Unless context dictates otherwise, “aggregate” (as used herein) refers to a particular filler material used in a cement-based composite. Examples of aggregate include (but are not limited to) sand, gravel, crushed stone, recycled concrete, and geosynthetic aggregates. Typically, a coarse aggregate is between about 5 mm to about 20 mm in diameter. In some embodiments the fine aggregate (sand) is less than about 5 mm in diameter. In some embodiments the gravel is about 10 mm in diameter or less.

Unless context dictates otherwise, “about” (as used herein) means near the stated value (i.e. within ±5% of the stated value).

Some embodiments provide repair mortar which can provide enhanced compatibility between the repair mortar overlay and a concrete substrate, thereby providing enhanced interfacial bond strength between the repair mortar and the substrate. The repair mortar is enhanced with cellulose fibrils. In some embodiments the cellulose fibrils represent a low volume fraction of the repair mortar (e.g. between about 0.05 vol. % to about 5 vol. % of cellulose fibrils). Time, energy, and cost intensive pre-treatment of the substrate may be circumvented through use of the repair mortars without compromising the quality of the repair and/or the interfacial bond strength between the repair mortar and the substrate. Premature delamination of repairs is reduced or eliminated improving the long-term durability and/or performance of repaired concrete substrates.

While a few studies have explored the benefits of adding cellulose nano and micro fibers to cement-based materials (Nilsson and Sargenius, 2011; Mejdoub et al., 2016; Onuaguluchi et al., 2014; Hisseine et al., 2018; Balea 2019), these studies show that the addition of cellulose fibers lower the porosity of cement-based materials. Lower porosity, while providing higher strength and higher elastic modulus, makes for a poor repair mortar because it lacks dimensional compatibility with the substrate and debonds easily (Emmons et al. 1993). The inventors have nevertheless determined that adding cellulose fibrils to a cement-based repair mortar as described herein surprisingly mitigates these disadvantages, for the reasons described elsewhere in this disclosure as well as at least in part due to unexpected electrochemical compatibility between the cement-based repair mortars of the present invention and rebar containing concrete substrates. Without being bound by theory, the inventors consider the unexpected and enhanced electrochemical compatibility may be due to at least the particular dimension ranges, surface area of the added cellulose fibrils, and/or proportion of cellulose fibrils having a certain aspect ratio, as described herein.

The repair mortars described herein comprise a dry mixture or a slurry of cellulose fibrils and a cement binder. In some embodiments dry cellulose fibrils and a dry cement binder are provided together or separately and combined with a liquid to form the repair mortar. The cellulose fibrils are provided as a heterogeneous mixture of cellulose fibrils of various sizes. In some embodiments the cellulose fibrils are prepared by applying a high shear force to an unfibrillated cellulosic material as is conventionally known to pull unfibrillated cellulose fibers apart. The energy applied to the unfibrillated cellulosic material and the method of fibrillation determine the degree of fibrillation. For example, low energy fibrillation of unfibrillated cellulose fibers first forms fragmented sheets and/or other aggregates of cellulose nanofibrils and/or cellulose microfibrils. High energy fibrillation forms singulated cellulose nanofibrils and/or cellulose microfibrils.

The cellulose fibrils described herein enhance the compatibility of the repair mortars with a concrete substrate, providing enhanced interfacial bond strength between the repair mortar and the substrate. Without being bound by theory, the inventors consider the aspect ratio of the cellulose fibrils described herein to contribute to the enhanced compatibility. In some embodiments the cellulose fibrils have a broad size distribution, with widths ranging from about 20 nm to about 30 μm and/or lengths ranging from about 1 μm to about 2,000 μm, or widths ranging from about 80 nm to about 500 nm and lengths ranging from about 100 μm to about 800 μm. In some embodiments the cellulose fibrils have an aspect ratio ranging from about 20 to about 500. In some embodiments at least 95% of the cellulose fibrils have an aspect ratio of at least 50.

In some embodiments the surface area of the cellulose fibrils is greater than the surface area of pulp fibers used conventionally to enhance or reinforce cement-based repair mortars. In some embodiments the surface area of the cellulose fibrils is about 80 m²/g, as measured by Brunauer-Emmett-Teller (BET) surface area determination. In other embodiments the surface area may be in the range of 60-100 m²/g.

The repair mortars require only a relatively small vol. % of the cellulose fibrils. In some embodiments the repair mortars comprise between about 0.05 vol. % to about 5 vol. % of cellulose fibrils. In some embodiments the repair mortars comprise about 0.1 vol. % of cellulose fibrils.

In some embodiments the aspect ratio in combination with the surface area of the and/or the concentration of the cellulose fibrils contribute to the enhanced compatibility of the repair mortars with a concrete substrate.

In some embodiments the WRV and/or the surface area of the cellulose fibrils contribute to the enhanced compatibility of the repair mortars with a concrete substrate. In some embodiments the WRV of the cellulose fibrils is greater than the WRV of pulp fibers used conventionally to enhance or reinforce cement-based repair mortars. In some embodiments the WRV of the cellulose fibrils ranges from about 2 (i.e. 2 g_{water}/g_{dry}) to about 5 (i.e. 5 g_{water}/g_{dry}).

In some embodiments the cellulose fibrils have a viscosity of about 1000 mL/g to about 5000 mL/g.

In some embodiments the cellulose fibrils have a density in the range of about 1300 kg/m³ to about 1500 kg/m³.

The cement binder may comprise any cement or mixture of cement or a supplementary cementitious material conventionally known as blended cement. Specific examples of hydraulic cement binders include (without limitation) one or more of aluminous cement, blast furnace cement, calcium aluminate cement, American Society for Testing and Materials (ASTM)-designated Type I Portland cement, ASTM-designated Type IA Portland cement, ASTM-designated Type Portland cement, ASTM-designated Type IIA Portland cement, ASTM-designated Type III Portland cement, ASTM-designated Type IIIA Portland cement, ASTM-designated Type IV Portland cement, ASTM-designated Type V Portland cement, hydraulic cement (e.g. white cement, grey cement, blended hydraulic cement, ASTM-designated Type IS-Portland blast-furnace slag cement, ASTM-designated Type IP and Type P-Portland-pozzolan cement, and ASTM-designated Type I (SM)-slag modified Portland cement), ASTM-designated Type GU-blended hydraulic cement, ASTM-designated Type HE-high-early-strength cement, ASTM-designated Type MS-moderate sulfate resistant cement, ASTM-designated Type HS-high sulfate resistant cement, ASTM-designated Type MH-moderate heat of hydration cement, ASTM-designated Type LH-low heat of hydration cement, ASTM-designated Type K expansive cement, ASTM-designated Type O expansive cement, ASTM-designated Type M expansive cement, ASTM-designated Type S expansive cement, regulated set cement, very high early strength cement, high iron cement, and oil-well cement.

In some embodiments the repair mortars comprise a water to cement binder ratio between about 0.2 to about 0.6. In some embodiments the repair mortars comprise a water to cement binder ratio between about 0.4 to about 0.6. Conventional concrete has a water to cement binder ratio of between about 0.4 to about 0.6. Conventional high-performance concrete has a water to cement binder ratio of between about 0.2 to about 0.3. A lower water to cement binder ratio typically imparts higher strength to the concrete.

In some embodiments the repair mortars comprise between about 20 vol. % to about 22 vol. % of the cement binder.

In some embodiments the repair mortar further comprises one or more fillers and/or chemical admixtures. Example fillers include (but are not limited to) sand, calcium carbonate, limestone, crushed stone, gravel, and aggregate. Example chemical admixtures include (but are not limited to) air-entraining agents, retarding agents, accelerating agents (e.g. catalysts, calcium chloride, calcium formate), plasticizers, polymers, corrosion inhibitors, alkali-silica reactivity reduction agents, bonding agents, coloring agents, defoamers, odor-masking agents (e.g. perfumes), dry dispersing agents (i.e. to improve flow and wettability of the dry material when admixed with a liquid).

In some embodiments the repair mortars comprise between about 45 vol. % to about 55 vol. % of one or more fillers. In some embodiments the repair mortars comprise between about 0.03 vol. % to about 0.3 vol % of one or more chemical admixtures. In some embodiments the repair mortars comprise between about 45 vol. % to about 55 vol. % of sand. In some embodiments the repair mortars comprise between about 3.5 vol. % to about 10 vol. % of silica fume.

Due to the WRV of cellulose fibrils, the repair mortars described herein may not require a moisture-retaining agent. However, in some embodiments, the repair mortars described herein include one or more moisture-retaining agents (also known as thickeners or viscosity modifying admixtures). Example moisture-retaining agents include (but are not limited to) high-molecular weight copolymers (e.g. hydroxypropyl methylcellulose (HPMC), hydroxyethyl methylcellulose (HEMC), welan and xanthan gums, etc.). In some embodiments the repair mortars comprise 0 wt % of one or more moisture-retaining agents. In some embodiments the repair mortars comprise between 0 wt % to about 0.08 wt % of one or more moisture-retaining agents. In some embodiments the repair mortars comprise between about 0.03 wt % to about 0.08 wt % of one or more moisture-retaining agents.

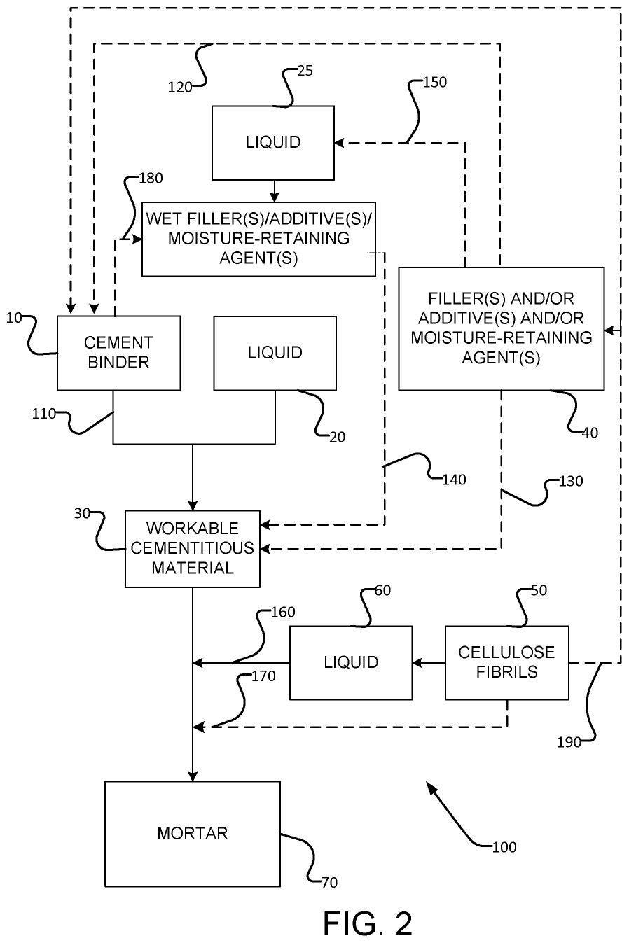

A method 100 of preparing a repair mortar 70 according to an example embodiment of the present invention is shown in FIG. 2. In step 110 a cement binder 10 is mixed with a liquid 20 (e.g. water) to provide a workable cementitious material 30. In some embodiments one or more fillers and/or chemical admixtures and/or moisture-retaining agents 40 may be mixed with cement binder 10 in dry or liquid state. For example, in optional step 120 one or more fillers and/or chemical admixtures and/or moisture-retaining agents 40 may be mixed in a dry state with the dry cement binder. One or more fillers and/or chemical admixtures and/or moisture-retaining agents 40 may be mixed in optional step 130 in a dry state with workable cementitious material 30. One or more fillers and/or chemical admixtures and/or moisture-retaining agents 40 may be individually or collectively mixed with a liquid 25 (e.g. water) in step 150 and the resultant liquid mixture(s) added to workable cementitious material 30 in step 140. The dry cement binder may alternatively be added to a liquid mixture of one or more fillers and/or chemical admixtures and/or moisture-retaining agents in step 180 to yield workable cementitious material 30.

Cellulose fibrils 50 are mixed with workable cementitious material 30 in step 160. In some embodiments cellulose fibrils 50 are mixed with a liquid 60 (e.g. water) to disperse the fibrils. The slurry of dispersed cellulose fibrils is then added to and mixed with workable cementitious material 30 in step 160 to provide the cellulose fibril-enhanced cement-based repair mortar 70. In some embodiments dry cellulose fibrils 50 are mixed with the workable cementitious material in step 170. In some embodiments dry cellulose fibrils 50 are mixed with one or more of dry cement binder 10, dry filler(s) and/or chemical admixture(s) and/or moisture-retaining agent(s) 40 in step 190. In some embodiments (not shown) dry cellulose fibrils 50 and/or the slurry of dispersed cellulose fibrils are mixed with a liquid mixture of one or more of filler(s), chemical admixture(s), and moisture-retaining agent(s). In some embodiments, a pan mixer and/or a drum mixer is used to mix the various components into liquid 20.

The method of mixing repair mortar 70 may impact the dispersion of cellulose fibrils throughout the repair mortar. For example, adding a thoroughly mixed aqueous suspension of cellulose fibrils 50 to a thoroughly mixed workable cementitious material 30 uniformly disperses cellulose fibrils 50 throughout the repair mortar. In some embodiments dry cellulose fibrils are thoroughly mixed with workable cementitious material 30 (with or without dry filler(s) and/or chemical additive(s) and/or moisture-retaining agent(s)). In some embodiments dry cellulose fibrils are thoroughly mixed with dry cement binder 10 and/or dry filler(s) and/or chemical additive(s) and/or moisture-retaining agent(s) 40.

In some embodiments repair mortar 70 is used to repair cracked or degraded concrete substrates and/or to fill the pores of a porous concrete substrate. The concrete substrate may be reinforced or not reinforced. For example, the concrete substrate may be reinforced with steel fibers and/or steel reinforcement bars (i.e. rebar). In some embodiments the surface of the concrete substrate to be repaired is pre-treated. For example, the surface of the concrete substrate to be repaired may be at least partially saturated with a liquid (e.g. water) and/or freed of dust and/or debris. In some embodiments the surface of the concrete substrate is pre-treated by scarification and/or roughening before repair mortar 70 is applied. Since the cellulose fibrils may be added to workable cementitious material, new equipment and/or modifications to existing equipment is not required.

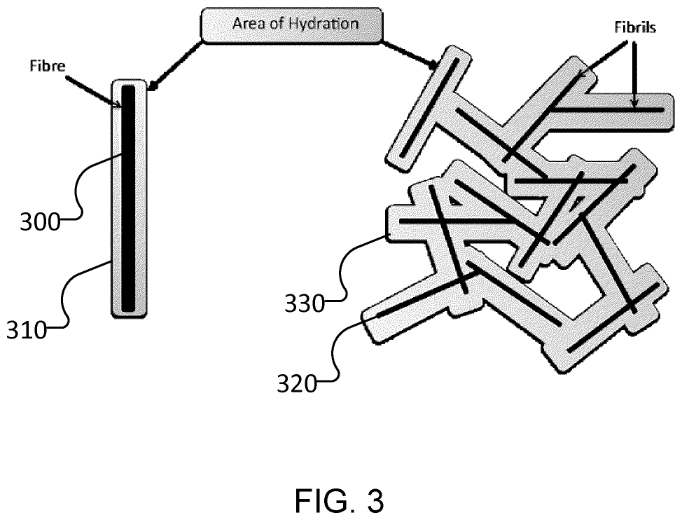

FIG. 3 shows the hydration area 310 of a conventional pulp fiber 300 and the hydration area 330 of cellulose fibrils 320. The hydration area of cellulose fibrils is several orders of magnitude greater than the hydration area of conventional pulp fibers, thereby increasing the internally-cured area of the repair mortars described herein. Since cellulose fibrils increase the internally-cured area in a repair mortar by several orders of magnitude, the cellulose fibril-enhanced repair mortars described herein dramatically improve the bond strength at the repair mortar-concrete substrate interface as compared to conventional non-fibrillated pulp fiber-enhanced cement-based repair mortars.

The water retention and desorption properties of cellulose fibrils enables cellulose fibrils to regulate moisture during cement curing and reduces and/or prevents the early-age autogenous shrinkage problem caused by cement hydration. Cellulose fibrils retain liquid, thereby maintaining the internal relative humidity of the repair mortar. Thus, liquid that would ordinarily bleed to the exposed surface of the repair mortar and evaporate in the absence of the cellulose fibrils, is retained by the cellulose fibrils and desorbs gradually. With reduced bleeding, micro-cracking induced by early-age volume changes is minimized and/or prevented. Cellulose fibrils distribute water throughout the repair mortar matrix evenly and sustain cement particle hydration during curing. Cellulose fibrils remain uniformly distributed throughout the repair mortar matrix during curing, demonstrating reduced settling and/or bleeding compared to the pulp fibers of non-fibrillated pulp fiber-enhanced cement-based repair mortars conventionally known. Without being bound by theory, it is speculated that the reduced bleeding may be attributed to the reduced quantity of free water in workable cellulose fibril-enhanced repair mortars. The reduced volumetric changes and/or sustained internal relative humidity and/or increased cement particle hydration of the cellulose fibril-enhance repair mortars described herein enhance the bond strength at the repair mortar-concrete substrate interface and/or reduces micro-cracking induced by early-age shrinkage.

In some embodiment the setting/hardening period for the cellulose fibril-enhanced cement-based repair mortars is similar to the setting/hardening period for conventional cement-based mortars.

### Example 1

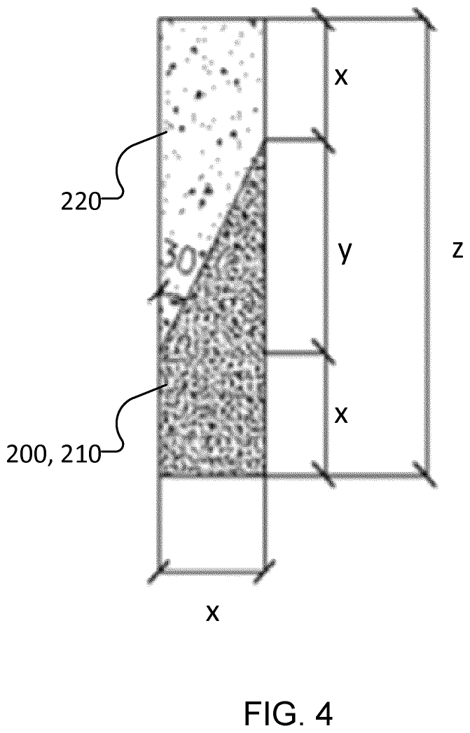

The American Society for Testing and Materials (“ASTM”) C882 (2013) slant shear test was used to evaluate the bond strength at the repair mortar-concrete substrate interface of example cellulose fibril-enhanced repair mortars. Four 75 mm×280 mm cylindrical specimens comprising cement-based repair mortar and concrete substrate half-cylinders were prepared and tested. An illustration of a lengthwise cross-section of an example specimen 200 is shown in FIG. 4. Example cylinder specimen 200 comprises a concrete substrate half-cylinder 210 and a cement-based repair mortar half-cylinder 220. The compositions of the repair mortar and the concrete substrate of each specimen are given in Table 1. A cement binder was mixed with fine aggregate and water to provide a workable cementitious material. The cellulose fibril used in this study was a product of a multi-step refinement of bleached Kraft pulp at 30% consistency. After the refinement, the resulting cellulose filaments were re-dispersed fully in water before final dewatering to about 10% consistency. The cellulose fibril is a material with nano-width/micro-length size distribution. In some embodiments the size distribution is: width of 80-500 nm and length of 100-800 μm, with a surface area of about 80 m²/g. The cellulose fibril slurry was mixed with the workable cementitious material to disperse the cellulose fibrils substantially uniformly throughout the workable cementitious material. To reduce or eliminate incompatibility (i.e. stiffness incompatibility) between the repair mortar and substrate, the composition of the repair mortar was selected so that its stiffness substantially corresponded to the stiffness of the substrate. Persons skilled in the art will understand that the stiffness of the repair mortar/substrate is a function of the composition of the repair mortar/substrate.

TABLE 1
Repair mortar and concrete substrate compositions with surface pretreatment.

| | | | | | | | | | | Steel | Cellulose | |
|---|---|---|---|---|---|---|---|---|---|---|---|---|
| | Half | | Cement | SF¹ | Coarse¹ | Fine¹ | Water | AEA¹ | HRWR¹ | fibers | fibrils | Surface |
| Mix | cylinder | w/c¹ | (kg/m³) | (kg/m³) | (kg/m³) | (kg/m³) | (kg/m³) | (wt %) | (wt %) | (vol. %) | (vol. %) | pretreatment |
| 1 | Substrate | 0.45 | 381 | — | 960 | 840 | 171.5 | 0.15 | 0.15 | 0.5 | — | rough |
| | Repair | 0.4 | 603 | 67 | — | 1380 | 268 | 0.02 | 0.8 | — | 0.1 | — |
| | mortar | | | | | | | | | | | |
| 2 | Substrate | 0.45 | 381 | — | 960 | 840 | 171.5 | 0.15 | 0.15 | 0.5 | — | rough |
| | Repair | 0.4 | 603 | 67 | — | 1380 | 268 | 0.02 | 0.27 | — | — | — |
| | mortar | | | | | | | | | | | |
| 3 | Substrate | 0.45 | 381 | — | 960 | 840 | 171.5 | 0.15 | 0.15 | — | — | rough |
| | Repair | 0.4 | 603 | 67 | — | 1380 | 268 | 0.02 | 0.8 | — | 0.1 | — |
| | mortar | | | | | | | | | | | |
| 4 | Substrate | 0.45 | 381 | — | 960 | 840 | 171.5 | 0.15 | 0.15 | — | — | rough |
| | Repair | 0.4 | 603 | 67 | — | 1380 | 268 | 0.02 | 0.27 | — | — | — |
| | mortar | | | | | | | | | | | |

¹“w/c” refers to the water:cement ratio; “SF” refers to silica fume; “coarse” refers to aggregate of about 12 mm in size; “fine” refers to aggregate of about 5 mm or less in size; “AEA” refers to the air entraining agent Darex ® II AEA; “HRWR” refers to the high range water reducer ADVA ® Cast 575.

To prepare each specimen, the half-cylinder concrete substrate was mixed, cast in a mold, and covered with a polyethylene sheet for 24 hours. Each concrete substrate was compacted in two layers (i.e. a half cylinder mold was half filled with the fresh concrete substrate mixture, vibrated using a shake table to remove entrapped air, filled with the fresh concrete substrate mixture, and then vibrated again. After de-molding, half-cylinders were moist-cured in a curing room for 14 days at 23° C. and 95% relative humidity (RH) according to ASTM C192/C192M-18, Standard Practice for Making and Curing Concrete Test Specimens in the Laboratory. The elliptical contact surface of some of the concrete substrate half-cylinders was subjected to a template-controlled surface roughness pre-treatment. Template-controlled surface roughness is a simple pre-treatment method that ensures a uniform substrate roughness. A perforated steel plate with 7.5 mm×1.4 mm openings was mounted on mold inserts prior to the concrete substrate placement, thereby creating a uniformly distributed protuberances on the surface of substrates after the casting and de-molding operations The already moist-cured concrete substrates were then cleaned and reinserted into the molds. A repair mortar was applied to each concrete substrate and the repair mortar compacted in two layers as described above. The specimens were covered with a polyethylene sheet for 24 hours and moist-cured in lime water (as described above) for 6 days at 23° C. and 95% RH. The specimens were each tested in pure compression (i.e. a compressive force was applied to each specimen until a failure along the bond plane (i.e. the substrate-repair mortar interface) was observed) under a load rate of 0.24 MPa/s using a Baldwin Tate-Emry compressive strength testing machine (manufactured by the Baldwin Lima Hamilton Corporation, Ohio, USA) having a 400,000 pound capacity. For all tested specimens, failures occurred at the repair mortar-concrete substrate interface.

The different stresses generated during the test were calculated using equations (1) to (3):

$${σ}_{v} = \frac{P v}{I α} \qquad ( 1 )$$

$$τ = {σ}_{v} Sin α Cos α \qquad ( 2 )$$

$${σ}_{n} = {σ}_{v} {Sin}^{2} α \qquad ( 3 )$$

where σᵥ is the applied vertical stress required to produce a failure along the bond plane, Pᵥ is the maximum applied failure load, τ and σₙ are respectively the shear and normal stresses acting on the bond plane, and Iₐ is the interface bonding surface area of the concrete substrate specimen. ASTM C882 (2013) recommends Iₐ equal 0.7854 ab, where a and b are the lengths of the two axes of the elliptical bond surface.

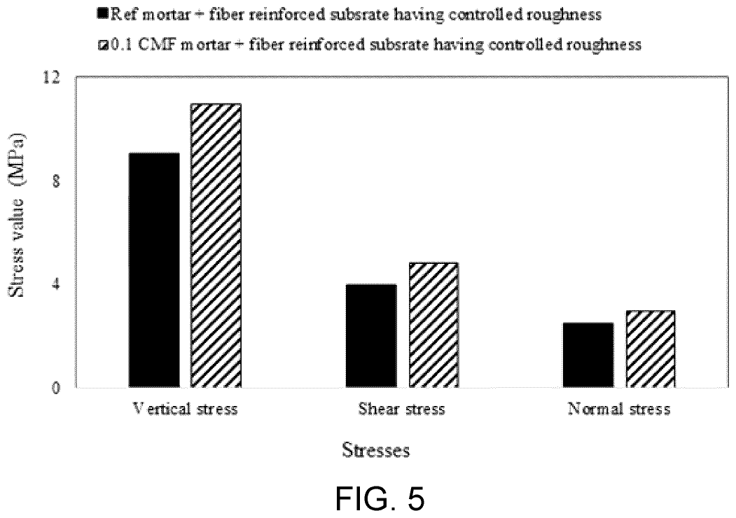

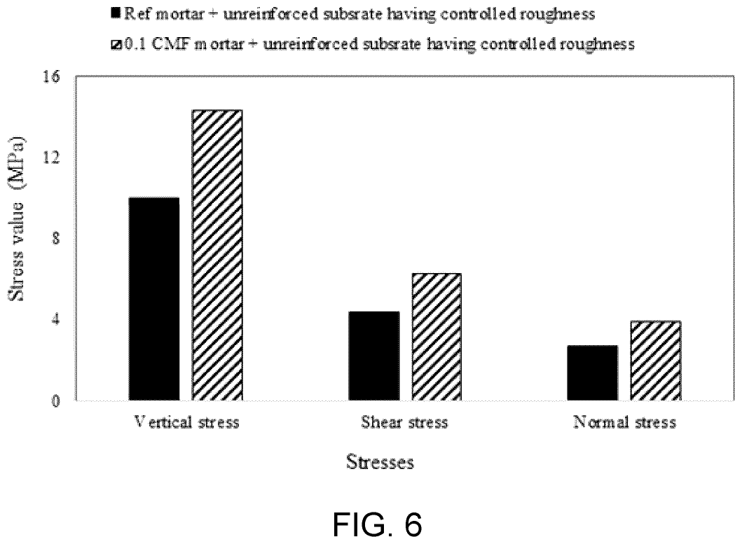

The slant shear test results of specimens (i.e. Mixes 1 and 2 set out in Table 1) with a steel-reinforced concrete substrate and controlled bond area surface roughness are shown in FIG. 5. The slant shear test results of specimens with unreinforced concrete and controlled bond area surface roughness are shown in FIG. 6. The cement-based repair mortars of the specimens were either enhanced with 0.1 vol. % cellulose fibrils (diagonally-lined bar) or not enhanced (solid bar). Improvements in the interfacial bond strength for the specimens comprising the cellulose fibril-enhanced cement-based repair mortars relative to non-enhanced specimens are apparent. While the relative bond strength percent enhancement for the 0.5% steel fiber-reinforced specimens was only about 20.7%, it was enhanced by about 43% for the unreinforced, cellulose fibril-enhanced specimens. Typically, the tendency for unrestrained non-linear deformation of the repair mortar to occur is higher for unreinforced substrates. Thus, the bond strength improvement of the cellulose fibril-enhanced specimens is emphasized where the specimens lacked steel fiber reinforcement.

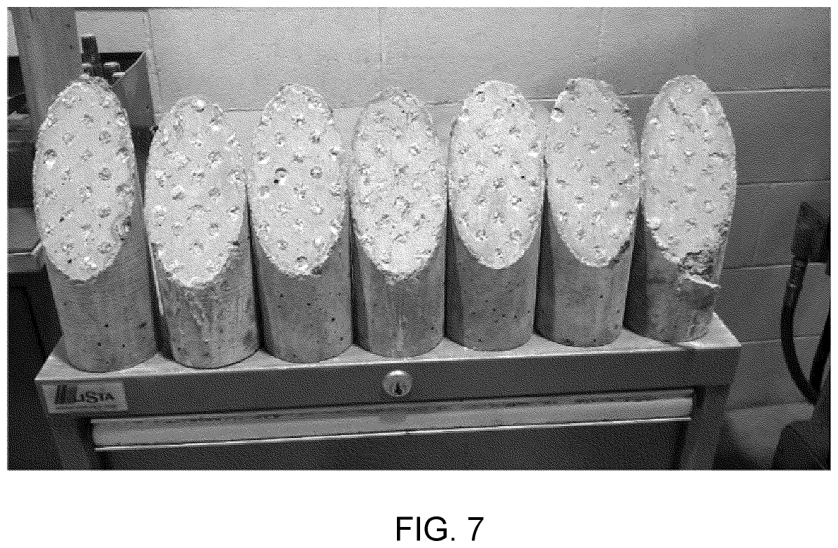

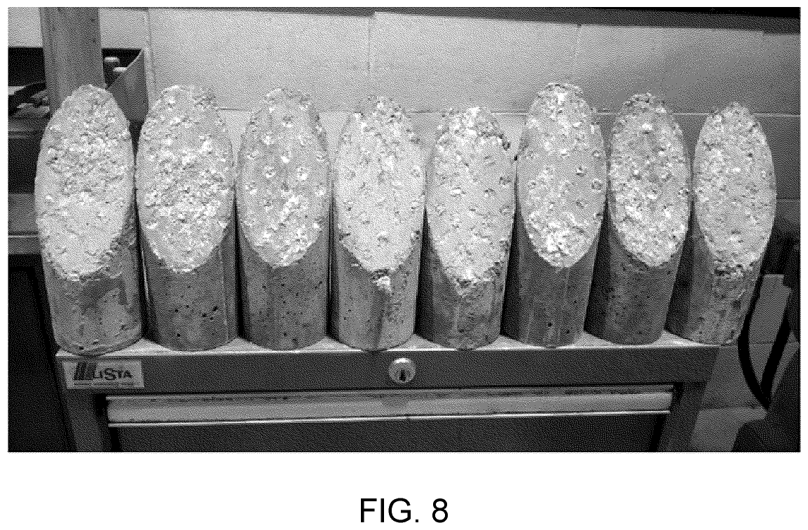

Images of the specimens post pure compression tests are shown in FIGS. 7 and 8. One of the half cylinder specimens was broken and, accordingly, FIG. 7 depicts only 7 specimens although 8 half cylinder specimens (i.e. four cylinder specimens) were prepared. The FIG. 7 specimens comprise the Mix 2 composition set out in Table 1. The FIG. 8 specimens comprise the Mix 1 composition set out in Table 1. The greater degree of surface scarification observed for the cellulose fibril-enhanced specimens shown in FIG. 8 suggests that, compared to the reference repair mortar (i.e. without cellulose fibrils), cellulose fibril-enhanced cement-based repair mortars produce a more compact repair mortar-substrate interfacial bond.

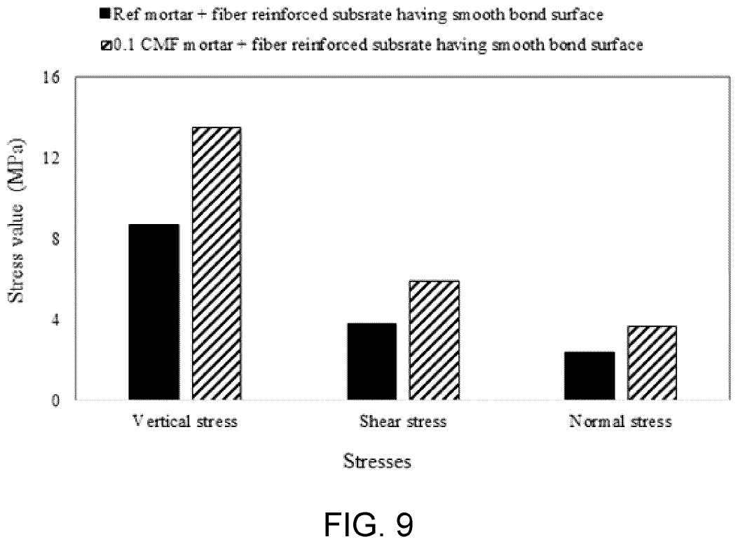

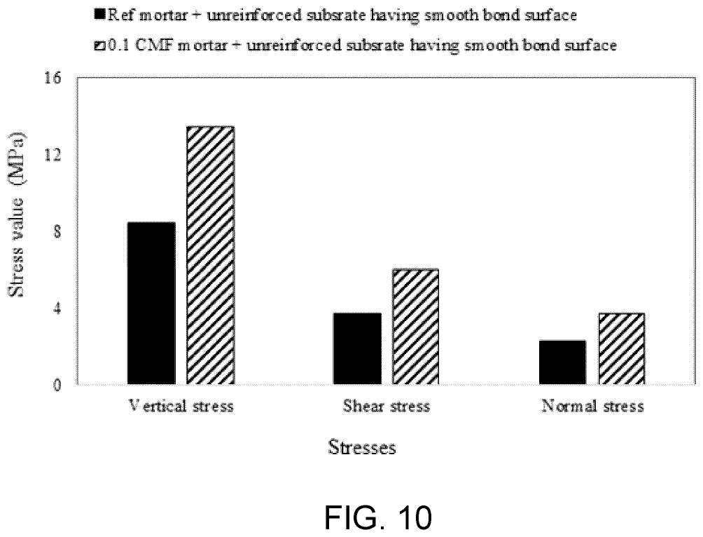

Slant shear tests were also performed to evaluate the impact of cellulose fibrils on the interfacial bond strength between the repair mortar/concrete substrate interface in the absence of concrete substrate surface pre-treatment. Four 75 mm×280 mm cylindrical specimens comprising cement-based repair mortar and concrete substrate half-cylinders were prepared and tested. The compositions of the repair mortar and the concrete substrate of each specimen are given in Table 2. A cement binder was mixed with water to provide a workable cementitious material. Cellulose fibrils were mixed with water to provide a cellulose fibril slurry. The cellulose fibril slurry was mixed with the workable cementitious material to disperse the cellulose fibrils substantially uniformly throughout the workable cementitious material. The results of the slant shear tests are shown in FIGS. 9 and 10. The cement-based repair mortars of the specimens were either enhanced with 0.1 vol. % cellulose fibrils (diagonally-lined bar) or not enhanced (solid bar).

TABLE 2
Repair mortar and concrete substrate compositions without surface pretreatment.

| | | | | | | | | | | Steel | Cellulose | |
|---|---|---|---|---|---|---|---|---|---|---|---|---|
| | Half | | Cement | SF¹ | Coarse¹ | Fine¹ | Water | AEA¹ | HRWR¹ | fibers | fibrils | Surface |
| Mix | cylinder | w/c¹ | (kg/m³) | (kg/m³) | (kg/m³) | (kg/m³) | (kg/m³) | (wt %) | (wt %) | (vol. %) | (vol. %) | pretreatment |
| 1 | Substrate | 0.45 | 381 | — | 960 | 840 | 171.5 | 0.15 | 0.15 | 0.5 | — | smooth |
| | Repair | 0.4 | 603 | 67 | — | 1380 | 268 | 0.02 | 0.8 | — | 0.1 | — |
| | mortar | | | | | | | | | | | |
| 2 | Substrate | 0.45 | 381 | — | 960 | 840 | 171.5 | 0.15 | 0.15 | 0.5 | — | smooth |
| | Repair | 0.4 | 603 | 67 | — | 1380 | 268 | 0.02 | 0.27 | — | — | — |
| | mortar | | | | | | | | | | | |
| 3 | Substrate | 0.45 | 381 | — | 960 | 840 | 171.5 | 0.15 | 0.15 | — | — | smooth |
| | Repair | 0.4 | 603 | 67 | — | 1380 | 268 | 0.02 | 0.8 | — | 0.1 | — |
| | mortar | | | | | | | | | | | |
| 4 | Substrate | 0.45 | 381 | — | 960 | 840 | 171.5 | 0.15 | 0.15 | — | — | smooth |
| | Repair | 0.4 | 603 | 67 | — | 1380 | 268 | 0.02 | 0.27 | — | — | — |
| | mortar | | | | | | | | | | | |

¹“w/c” refers to the water:cement ratio; “SF” refers to silica fume; “coarse” refers to aggregate of about 12 mm in size; “fine” refers to aggregate of about 5 mm or less in size; “AEA” refers to the air entraining agent Darex ® II AEA; “HRWR” refers to the high range water reducer ADVA ® Cast 575.

For reinforced concrete substrate specimens (FIG. 9), a slight reduction in bond strength was observed for the untreated non-enhanced specimens relative to a surface pre-treated non-enhanced specimens (FIG. 5). Relative to the non-enhanced repair mortar overlaid on untreated 0.50% fiber reinforced substrate, the shear bond strength of the cellulose fibril enhanced repair mortar-0.50% fiber reinforced substrate composite increased by about 56%. (FIG. 9). For unreinforced concrete substrate specimens (FIG. 10), bond strength was observed to increase by about 63% for the untreated cellulose fibril-enhanced specimens relative to the untreated non-enhanced specimens (FIG. 10). Since a roughened (i.e. pre-treated) surface typically serves to enhance the mechanical bond between a repair mortar and a concrete substrate, reduced bond strength is expected for an untreated (i.e. smooth) specimens. Accordingly, the reason for the observed bond strength enhancement by the cellulose fibril-enhanced specimens is unclear. Without being bound by theory, it is speculated that with a smooth concrete substrate surface, hydration is sustained by uniformly distributed cellulose fibrils at the repair mortar-substrate interface.

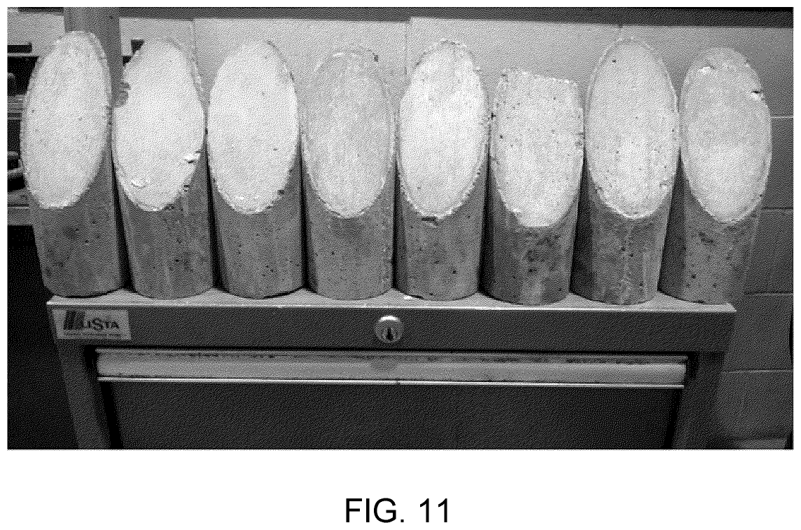

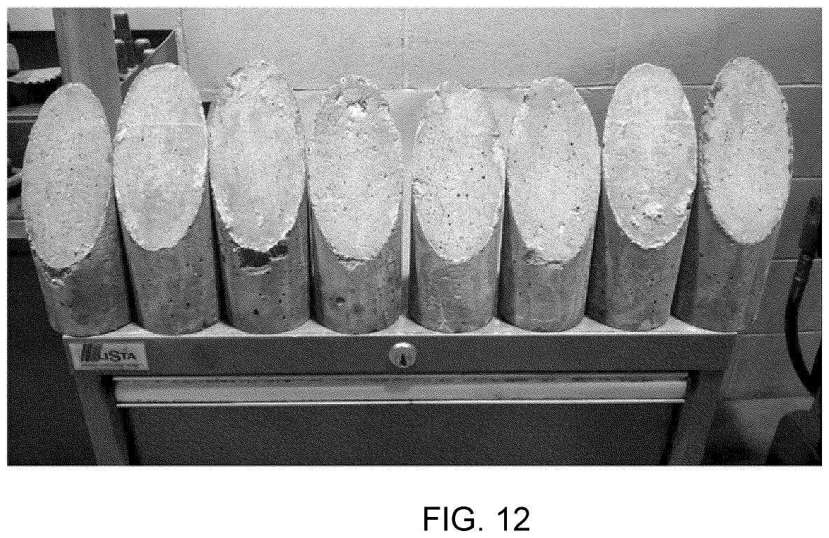

Images of the specimens (i.e. Mixes 3 and 4 set out in Table 2) post pure compression tests are shown in FIGS. 11 and 12. The FIG. 11 specimens comprise the Mix 4 composition set out in Table 2. The FIG. 12 specimens comprise the Mix 3 composition set out in Table 2. The greater degree of surface scarification observed for the cellulose fibril-enhanced specimens shown in FIG. 12 suggests that, compared to the reference repair mortar (i.e. without cellulose fibrils), cellulose fibril-enhanced repair mortars produce a more compact repair mortar-substrate interfacial bond.

Relative to the slant shear test results of non-enhanced repair mortar overlaid on steel fiber-reinforced concrete substrate and template-controlled surface roughness pre-treatment, the shear bond strength for the cellulose fibril enhanced composite incorporating fiber reinforced substrates was observed to increase by about 21% (FIG. 5). Relative to the slant shear test results for specimens comprising of a non-enhanced repair mortar overlaid on an unreinforced concrete substrate and template-controlled surface roughness pre-treatment, slant shear bond strength was observed to increase by about 43% for the corresponding cellulose fibril-enhanced specimens (FIG. 6). The impact of cellulose fibrils on interfacial bond strength is even more apparent for specimens devoid of concrete substrate surface pre-treatment (i.e. smooth surface concrete substrates). Relative to the slant shear test results for specimens comprising of a non-enhanced repair mortar overlaid on an untreated steel fiber-reinforced concrete substrate, slant shear bond strength was observed to increase by about 56% for the corresponding cellulose fibril-enhanced specimens (FIG. 9). Relative to the slant shear test results for specimens comprising of a non-enhanced repair mortar overlaid on an untreated unreinforced concrete substrate, slant shear bond strength was observed to increase by about 63% for the corresponding cellulose fibril-enhanced specimens (FIG. 10). Accordingly, interfacial bond strength is enhanced by cement-based repair mortars comprising cellulose fibrils.

### Example 2

The effects of non-enhanced and cellulose fibril enhanced repair mortar overlays on steel rebar corrosion were evaluated. Specifically, steel reinforcement corrosion risk in two types of rebar arrangements in repair composites was investigated, steel rebar completely encapsulated by concrete substrate/repair mortar overlay and steel rebar located directly at the substrate-overlay interface. Steel rebar corrosion performance was monitored via measurements such as corrosion current, initial crack formation time in specimens, surface crack width evolution, corrosion rate and residual pullout force of corroded reinforcement bars.

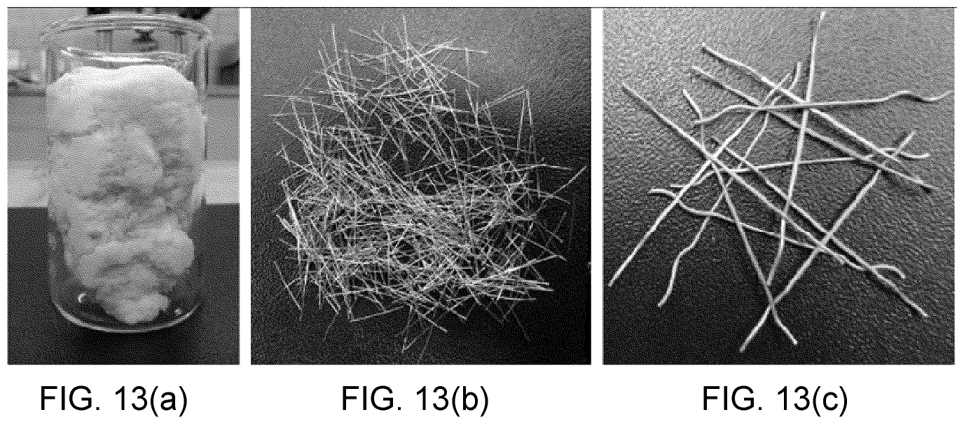

Ordinary Portland cement (OPC), natural sand, fine aggregate and 12 mm-sized crushed rock coarse aggregate having a specific gravity of 2.65 and 2.70, respectively were used. The cellulose fibril used in this study was a product of a multi-step refinement of bleached Kraft pulp at 30% consistency. After the refinement, the resulting cellulose filaments were re-dispersed fully in water before final dewatering to about 10% consistency. The cellulose fibril is a material with nano-width/micro-length size distribution. In some embodiments the size distribution is: width of 80-500 nm and length of 100-800 μm, with a surface area of about 80 m²/g. A 10M deformed, carbon steel rebar and 13 mm brass coated steel micro-fiber (Dramix OL 13/0.20) were the reinforcements used. The other materials utilized in mixture preparation were Darex air-entraining admixture (AEA) and ADVA CAST 575 high-range water reducing admixture (HRWR). A pictorial description of the cellulose fibril and steel fibers utilized in this study is shown in FIGS. 13(a) to 13(b).

In order to minimize elastic modulus mismatch between concrete substrate and repair mortar overlays as well as poor dispersion of the cellulose fibril in repair mortar mixtures, trial batches of different classes of concrete and repair mortar mixtures were prepared and evaluated. Based on the preliminary results, two types of mixtures consisting of 0.45 water-cement (w/c) ratio concrete for substrates and 0.40 w/c ratio repair mortar overlay mixtures with the mix proportions shown in Table 1 were prepared and used in the main study. While some of the substrates were unreinforced, others were reinforced with 0.50% steel fibers. Non-enhanced and cellulose fibril enhanced repair mortar mixtures were reinforced with 0% and 0.1% volume fraction of the cellulose fibril, respectively. To ensure a fair comparison among the mixtures, the w/c ratio of mixtures was kept constant by reflecting the moisture content of the cellulose fibril slurry in the mix design. For all the tests, repair mortar overlays were placed 24 h after the substrates were cast. Thereafter, relevant tests were performed after additional 13 days of moist-curing of composite specimens at a temperature of 23° C. and 95±5% RH.

TABLE 3
Concrete substrate and repair mortar overlay mixture proportions

| | | | | | | Steel | Cellulose | | | |
|---|---|---|---|---|---|---|---|---|---|---|
| | w/c | Cement | SF¹ | Coarse¹ | Fine¹ | fiber | fibrils | Water | AEA¹ | HRWR¹ |
| | ratio¹ | (kg/m³) | (kg/m³) | (kg/m³) | (kg/m³) | (vol. %) | (vol. %) | (kg/m³) | (%/bwoc) | (%/bwoc) |
| Substrate | 0.45 | 381 | — | 960 | 840 | 0.50 | — | 171.5 | 0.15 | 0.24 |
| Overlay | 0.4 | 603 | 67 | — | 1380 | 0.0 | 0.1 | 268 | 0.02 | 0.27-0.8 |

¹“w/c” refers to the water:cement ratio; “SF” refers to silica fume; “coarse” refers to aggregate of about 10 mm in size; “fine” refers to aggregate of about 5 mm or less in size; “AEA” refers to the air entraining agent Darex ® II AEA; “HRWR” refers to the high range water reducer ADVA ® Cast 575.

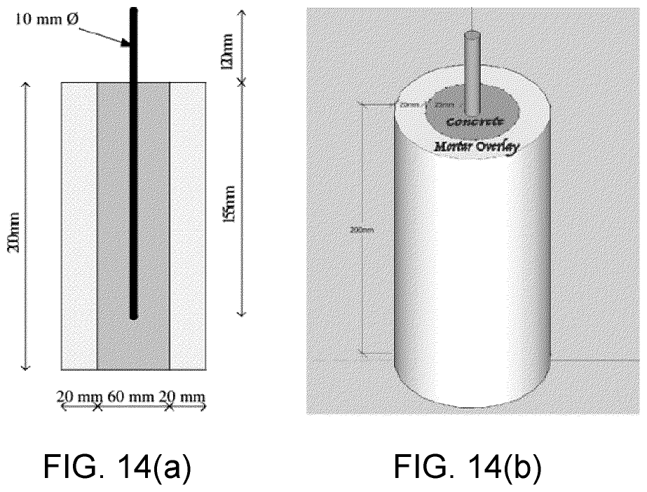

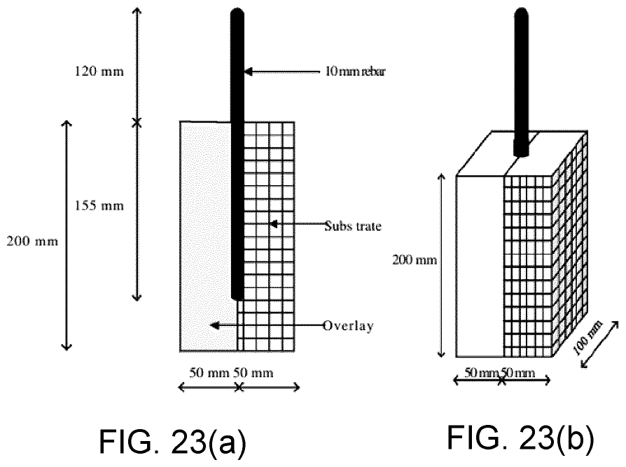

Accelerated rebar corrosion tests were conducted. Steel reinforcement corrosion protection in unreinforced and 0.5% steel fiber reinforced concrete substrates overlaid with non-enhanced and cellulose fibril enhanced repair mortar were evaluated. Two sets of specimens were tested. Whereas FIGS. 14(a) and 14(b) show a typical description of the first set of corrosion test specimen (100 mm×200 mm composite cylinders), the description for the second set of specimens is given in FIGS. 23(a) and 23(b) (200 mm×100 mm×50 mm prisms bonded together). For each repair substrate-overlay type investigated, three specimens were tested.

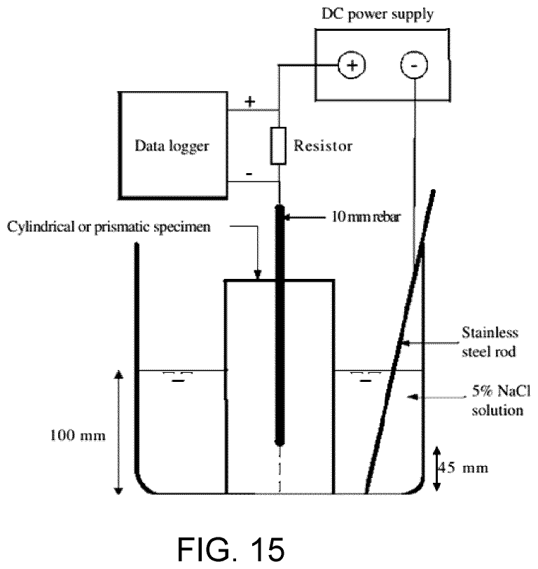

Prior to the embedment of un-corroded, deformed (ribbed) steel reinforcement bars in substrates, reinforcements were cleaned thoroughly using an acetic acid solution, and the initial mass determined. After 24 h of casting, overlays were placed on the substrates. The demolded composites were then moist-cured for an additional 13 days. The first set of cylindrical specimens were partially immersed to half height in a container of 5% NaCl solution and an impressed voltage of 25 V was applied to accelerate the corrosion process for 14 days. On the other hand, to evaluate the effect of different corrosion degree on the performance of steel reinforcement bar located directly at the concrete substrate-repair mortar overlay interface, variable impressed voltages of 7.5 V, 15 V and 25 V were used in testing the prismatic specimens over test durations of 21 days, 14 days and 8 days, respectively. FIG. 15 shows the set up of the accelerated corrosion test.

For each specimen, monitoring of corrosion induced crack width propagation commenced once crack initiation was visually observed during the test. Images of longitudinal cracks in specimens were taken daily with a high-resolution digital camera until the end of the test period. Thereafter, these images were processed using an open source image analysis software. At the end of the accelerated corrosion test, extracted reinforcements were cleaned with a wire brush before being left for 24 h in an acetic acid solution. Thereafter, reinforcements were re-brushed, dried, gently sandblasted using a pressure of 85 psi and weighed. The same cleaning technique was used for all reinforcement bars. Using the actual mass loss of reinforcement bars, the rebar corrosion rate in each repair system was calculated using Equation 6: ASTM G1-03 (2017).

$$C R = \frac{8.76 \times {10}^{4} Δ m}{A T ρ} \qquad ( 6 )$$

where CR is the corrosion rate in mm per year, Δm is the mass loss in grams, A is the surface area of steel rebar exposed to corrosion in cm2 and ρ is the steel rebar density in g/cm3, and T is the exposure time in hours.

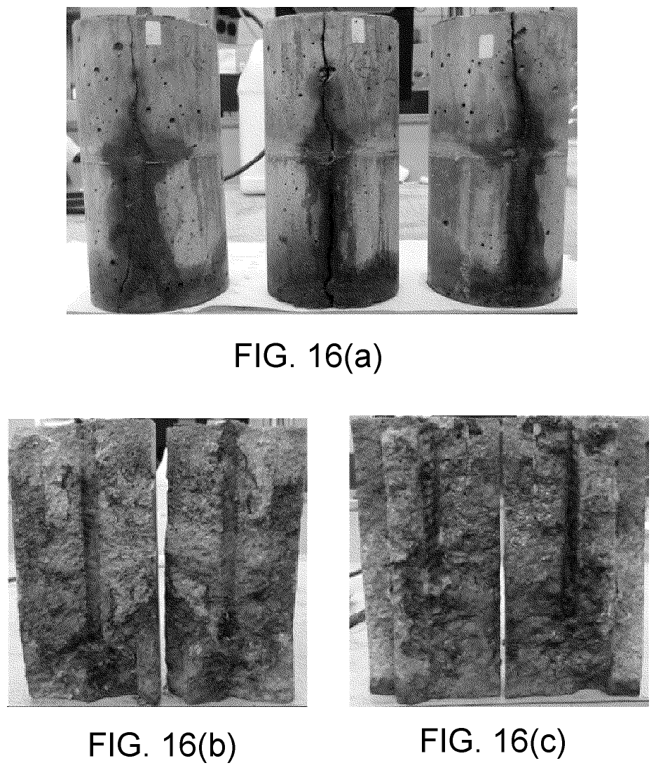

FIGS. 16(a) to 16(c) show a typical image summary of the cylindrical specimens after the corrosion test. For all the specimens tested, steel rebar corrosion induced cracking of specimen occurred longitudinally, in the vicinity of the embedded steel rebar. Similarly, corrosion residues (oxides) observed in split specimens were generally lower in specimens incorporating cellulose fibril enhanced repair mortar (FIG. 16(c)) compared to specimens incorporating no CMF (FIG. 16(b)).

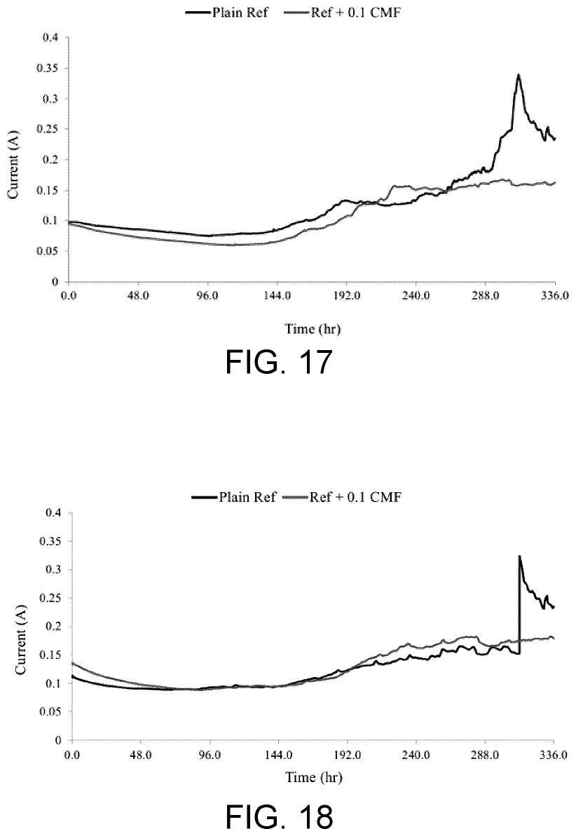

The average steel rebar corrosion current in plain substrate-repair mortar overlay and steel fiber reinforced substrate-repair mortar overlay composites are shown in FIGS. 17 and 18, respectively. From FIG. 17, it is quite clear that corrosion activity was lower in composite cylinders incorporating cellulose fibril enhanced repair mortar. Although FIG. 17 shows that the initial current in both sets of plain substrate overlaid with either non-enhanced or cellulose fibril enhanced repair mortar was about 0.1 A, corrosion current decreased as an oxide layer was formed on reinforcement bars until the expansive stress from the rust layer led to micro-cracking at the rebar-matrix interface. Compared to the repair composites prepared with the non-enhanced repair mortar overlay, matrix cracking and the consequent increase in the influx of the test solution and corrosion current increase was less rapid in the repair system prepared with the cellulose fibril enhanced repair mortar. Conversely, a slightly different trend is shown in FIG. 18 for steel fiber reinforced substrate-repair mortar overlay specimens. First, the addition of steel fibers to the substrate increased the initial corrosion current of specimens. The increase in current is traced to the capacity of the brass coated micro-fibers dispersed randomly in the substrate to enhance its conductivity. Although, corrosion activity in both sets of repair specimens was more rapid compared to the plain substrate-repair mortar overlay composites, specimen deterioration appears to be less severe in composites where the cellulose fibril enhanced repair mortar was used as the overlay material.

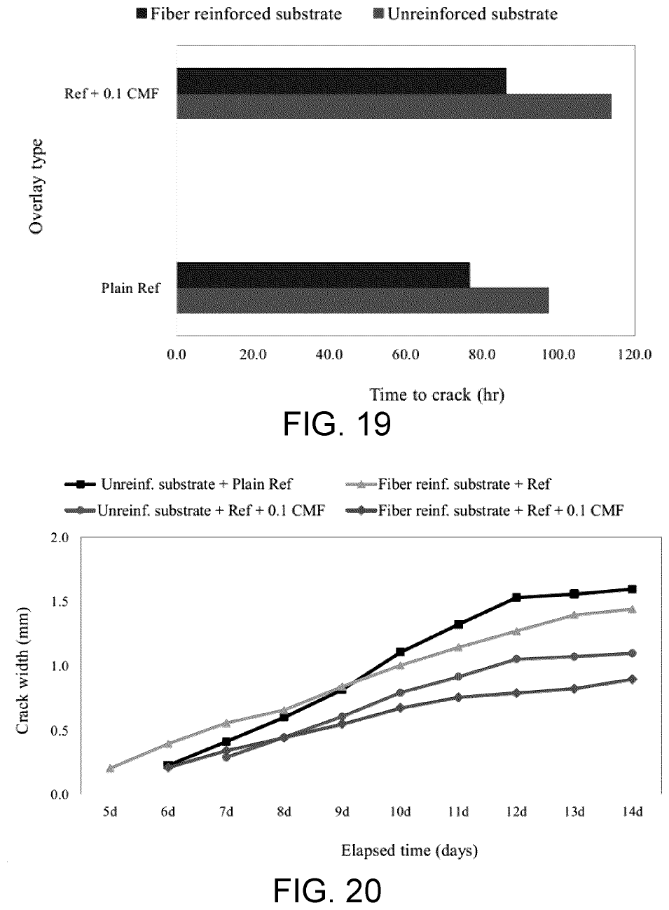

The time taken for micro-cracks to be initiated close to the interface between a corroding steel bar and the adjacent matrix in cylindrical composite specimens is shown in FIG. 19. For both plain and steel fiber reinforced substrates, the results shown in FIG. 19 indicate that micro-crack initiation occurred earlier in composite specimens prepared with non-enhanced repair mortar as the overlay. It is also clear from FIG. 19 that the addition of brass coated steel micro-fiber to substrates expedited crack initiation in the two sets of repair composites, with the impact more severe for the non-enhanced repair mortar overlay.

FIG. 20 shows surface crack width evolution in cylindrical composite specimens. Although steel fibers increased the conductivity of specimens, thereby predisposing them to early cracking, the crack bridging capacity of these fibers helped in minimizing crack width propagation in specimens. Hence, for the two sets of repair composites, average maximum crack width at the end of the test was lower in comparison to what was observed in composite specimens prepared with unreinforced substrates. The most important inference from FIG. 20 is that relative to the non-enhanced repair mortar overlays, the use of cellulose fibril enhanced repair mortar overlays reduced the crack width by about 31-37.5%. This improved crack control observed in composite specimens incorporating cellulose fibril enhanced repair mortar is traceable to two factors, first is the reduced volume of rebar corrosion by-products generated in specimens which ultimately led to a lower crack propagating expansive pressure. Secondly, compared to the non-enhanced repair mortar overlay, the more improved bond between the cellulose fibril enhanced repair mortar overlay and the substrate might have mitigated the movement of the cracked overlay.

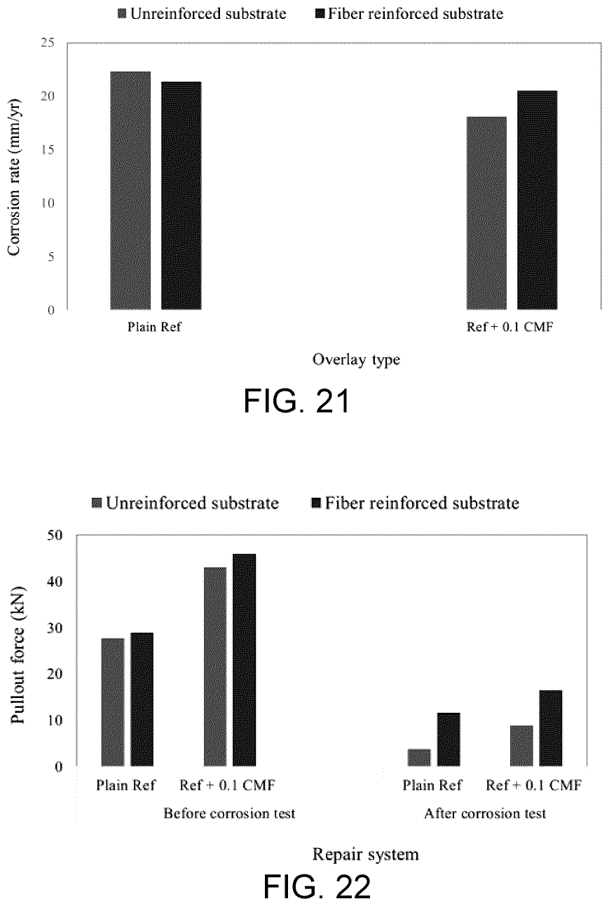

With the actual corrosion induced rebar mass losses, the rebar corrosion rates in the two sets of repair composites were calculated and shown in FIG. 21. The use of cellulose fibril enhanced repair mortar slightly reduced the corrosion rate of steel reinforcement in composites, especially for the composites prepared with unreinforced substrates. The rebar pullout result before and after the accelerated corrosion test is shown in FIG. 22. The first observation from FIG. 22 is that while the addition of steel fiber to substrate slightly enhanced the ultimate pullout force, the influence of the steel fibers was made more manifest after the steel reinforcement bar had partly deteriorated. On the other hand, the superior confinement provided by the cellulose fibril enhanced repair mortar led to pullout performance superior to that of the non-enhanced repair mortar for both corroded and un-corroded steel bars.

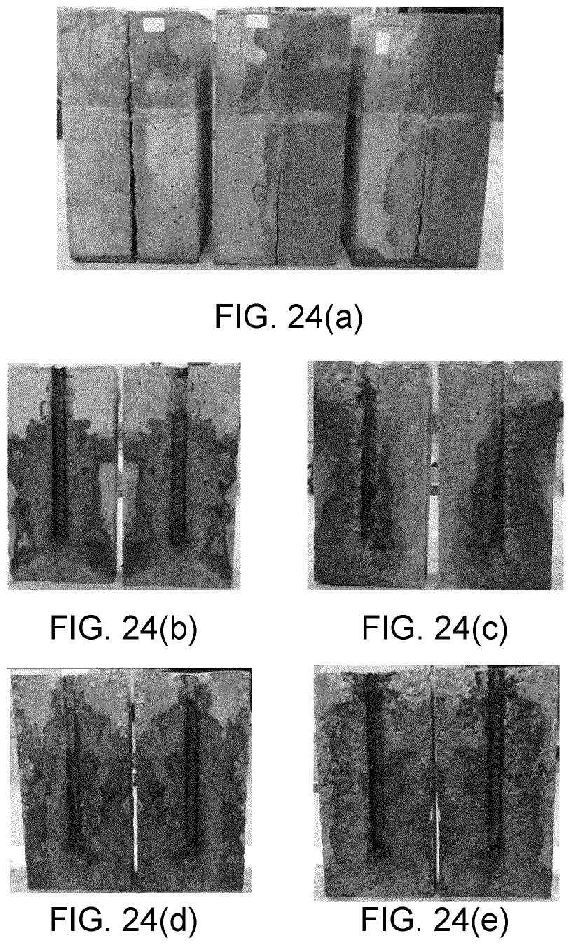

Some images of corrosion test prisms (unreinforced substrate-repair mortar overlay) after 15V and 25V accelerated corrosion tests are shown in FIGS. 24(a) to 24(e). FIGS. 24(a) to 24(c) show results from the 15V corrosion test, and FIGS. 24(d) and 24(e) show results from the 25V corrosion test. FIG. 24(a) confirms that the buildup of corrosion by-products at the substrate-overlay interface would ultimately lead to repair failure over time. It is also apparent from FIGS. 24(b) and 24(c) that steel rebar corrosion was somewhat reduced in prisms incorporating cellulose fibril enhanced repair mortar as the overlay. However, FIGS. 24(d) and 24(e) indicate that as the corrosion rate significantly increased, the benefit accruing from the use of the cellulose fibril enhanced repair mortar diminished. This is understandable given that at higher impressed voltage, increased rate of rebar corrosion and build up byproducts would have partly obscured whatever matrix transport/permeability and bond strength advantages engendered by the cellulose fibril enhanced repair mortar overlay.

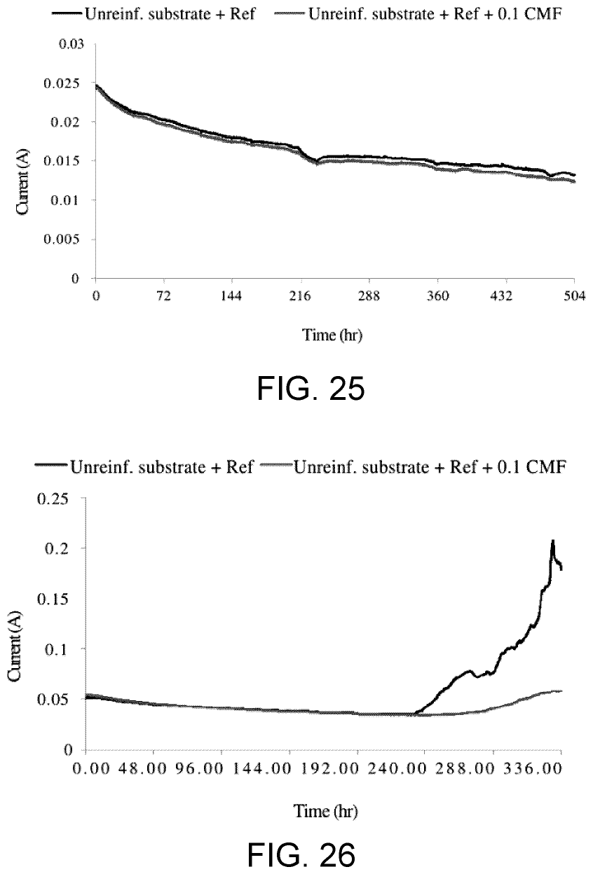

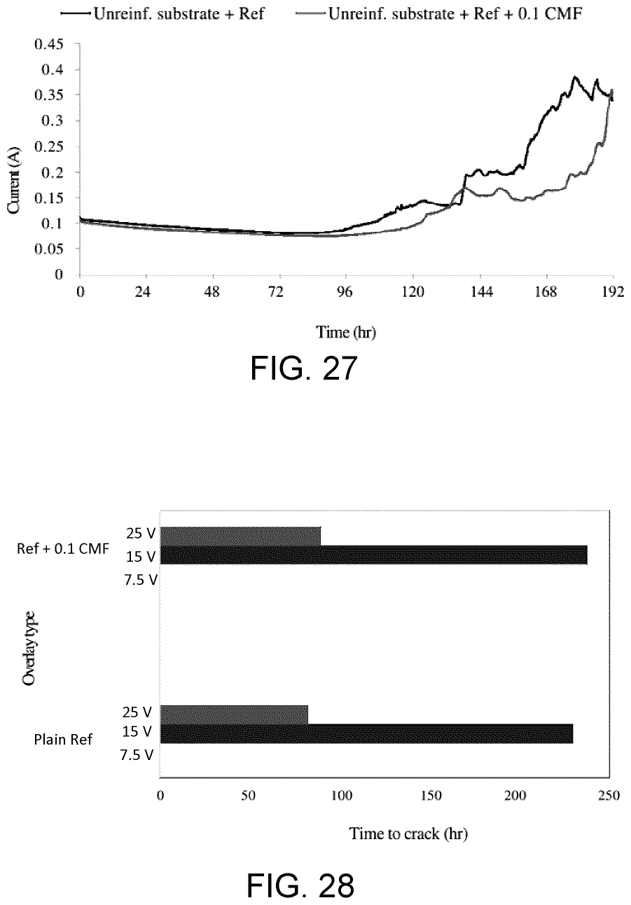

The average corrosion current measured in repair composite with steel reinforcement bar sandwiched in between plain concrete substrate and repair mortar overlays are shown in FIGS. 25 and 26. FIG. 25 shows despite the very low-level rebar corrosion induced with an applied voltage of 7.5V, a slight difference in performance between the non-enhanced and cellulose fibril enhanced repair mortar is still visible, with the latter showing a slightly lower corrosion current. However, because of the very low corrosion generated in the test prisms, specimens did not crack even after 21 days. Conversely, as the applied voltage was increased to 15V, FIG. 26 highlights a clear difference in the response of the two sets of repair composites. The specimen overlaid with the non-enhanced repair mortar did not only crack earlier, crack opening and current evolution was more rapid. A similar trend was also highlighted in FIG. 27 when the applied voltage was raised to 25V. However, the use of 25V to accelerate the corrosion process precipitated a massive rate of corrosion that partly vitiated the effectiveness of the cellulose fibril enhanced repair mortar overlay in providing protection to the steel rebar. Nonetheless, it is still very clear from FIG. 27, that the corrosion performance of a steel reinforcement bar located at the substrate-repair overlay interface is better if the overlay is made of cellulose fibril enhanced repair mortar.

The average time required for initial micro-cracks to occur in test prisms is shown in FIG. 28. While no crack occurred in specimens when an impressed voltage of 7.5V was used, the crack occurrence time for the impressed voltage of 15V was 229 hours for the plain substrate-non-enhanced repair mortar overlay and 237 hours for the plain substrate-cellulose fibril enhanced repair mortar overlay. Although, further increase of the impressed voltage to 25V fast-tracked micro-cracking in specimens, a trend similar to that of the 15V test was also observed. The micro-crack occurrence time in the 25 V accelerated test were 82 hours for the plain substrate-non-enhanced repair mortar overlay and 89 hours for the plain substrate-cellulose fibril enhanced repair mortar overlay. Comparing these results with that of the cylindrical repair composites tested with the same impressed 25V, it is apparent that failure initiated earlier in prismatic composites. This is unsurprising given that while the steel rebar in cylindrical specimen was fully encapsulated by the concrete substrate and repair mortar overlay, the location of the steel rebar at the substrate-overlay interface in prismatic specimen makes it easily accessible to the test solution and oxygen. Furthermore, compared to the substrate/overlay matrices, the interface has a higher widening proclivity once the expansive stresses from the corrosion by-products had exceeded the substrate-overlay bond strength.

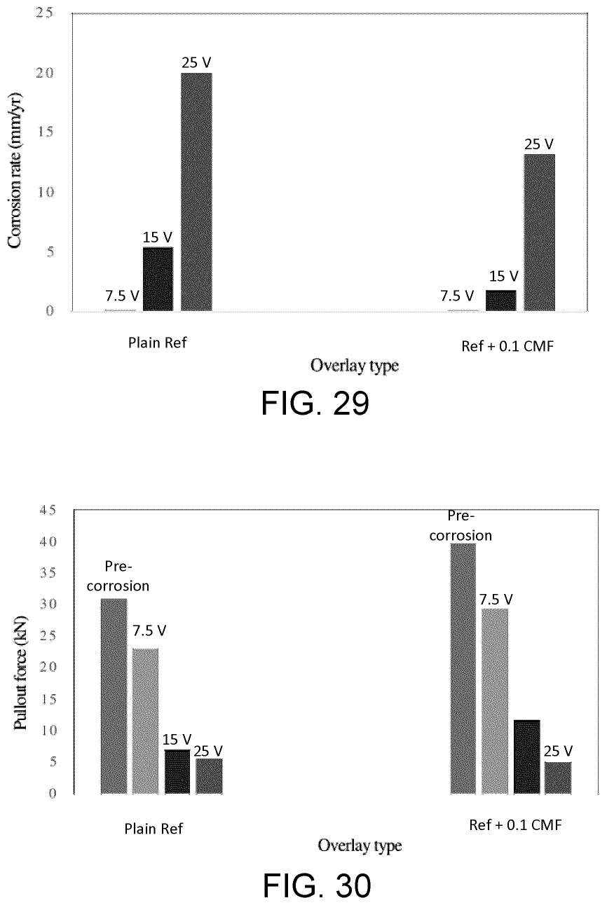

FIG. 29 shows steel rebar corrosion rate calculated from actual mass losses recorded at the end of each test, and as expected corrosion rates were lower in repair composites incorporating the cellulose fibril enhanced repair mortar as the overlay. For the 15V accelerated corrosion test, corrosion rate relative to that of the non-enhanced repair mortar composite decreased from 5.4 to 1.8 mm/yr. However, for the 25V test, the corrosion rate increased steeply to about 20 mm/yr. for the plain substrate-non-enhanced repair mortar overlay and 13.0 mm/yr. for the plain substrate-cellulose fibril enhanced repair mortar overlay. The main inference from these results is that for mild or medium level corrosion, the cellulose fibril enhanced repair mortar is quite effective in minimizing the onset of steel reinforcement bar degradation and general corrosivity.

Residual rebar pullout force results are shown in FIG. 30, and it indicates that rebar pullout resistance generally decreased as the corrosion level became higher. This is expected given that higher degree of rebar corrosion translated to increases in rebar section loss and deposition of friable rust adjacent to the steel rebar. Hence, reductions in rebar mechanical and frictional resistance, as well as increased delamination at the substrate-overlay interface culminated to the low pullout resistance observed. Irrespective of the foregoing, t for all the corrosion levels evaluated, the residual rebar pullout force in composites incorporating the cellulose fibril enhanced repair mortar overlay was superior to that of composites prepared with the non-enhanced repair mortar.

For steel reinforcement bars embedded in either unreinforced or steel fiber reinforced concrete cylinders, before a further encapsulation with repair mortar overlay was undertaken, results indicated that the cellulose fibril enhanced repair mortar provided superior resistance to the ingress of chlorides and rebar corrosion. Hence, micro-cracking of repair composite was not only delayed in specimen incorporating the cellulose fibril enhanced repair mortar, average crack width and corrosion rate were also reduced relative to specimens prepared with the non-enhanced repair mortar.

Although the addition of brass coated steel micro-fiber to substrates expedited crack initiation in the two sets of repair composites investigated, the negative impact was more severe for the fiber reinforced substrate-non-enhanced repair mortar composite. However, these steel micro-fibers were not only effective in reducing crack width propagation and ingress of the test solution, they reduced the rebar corrosion rate in repair composites. Moreover, the positive influence of steel fibers on rebar pullout resistance was made more manifest after corrosion induced section loss has taken place in steel reinforcement bars.

For reinforcement bars located at the substrate-overlay interface, it was confirmed that the buildup of corrosion by-products at the substrate-overlay interface would ultimately lead to repair failure overtime. However, test results equally showed that the use of cellulose fibril enhanced repair mortar as an overlay material provided superior protection against rebar corrosion. The aforesaid enhanced protection provided by the cellulose fibril enhanced repair mortar was more effective for mild or medium level corrosion activity.

Despite the fact that corroded rebar pullout resistance generally decreased as the impressed voltage used in accelerating the corrosion process increased from 7.5-25V, the residual corroded rebar pullout force in composites incorporating the cellulose fibril enhanced repair mortar were better than those of corresponding non-enhanced reference repair mortar overlaid substrates.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Where a component (e.g. a substrate, assembly, device, manifold, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments described herein.

Specific examples of systems, methods, and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1-41. (canceled)

42. A repair mortar comprising a cement binder, fine aggregate and cellulose fibrils, wherein the cellulose fibrils are dispersed uniformly throughout the repair mortar, wherein the cellulose fibrils comprise nanofibrillated cellulose and/or microfibrillated cellulose, wherein the cellulose fibrils comprise an aspect ratio of between about 20 to about 500, wherein the cellulose fibrils have a width of between about 20 nm to about 30 μm, wherein the cellulose fibrils have a length of between about 1 μm to about 2,000 μm, wherein the cellulose fibrils comprise between about 0.05 vol. % and about 5 vol. %, or about 0.1 vol % of the repair mortar, and wherein the surface area of the cellulose fibrils is between 60-100 m²/g.

43. The repair mortar according to claim 42 wherein the surface area of the cellulose fibrils is about 80 m²/g.

44. The repair mortar according to claim 42 wherein the water retention value (WRV) of the cellulose fibrils is between about 2 and about 5, wherein the density of the cellulose fibrils is between about 1,300 kg/m³ and about 1,500 kg/m³, and wherein the viscosity of the cellulose fibrils is between about 1,000 mL/g and about 5,000 mL/g.

45. The repair mortar according to claim 42 wherein the cement binder comprises one or more of aluminous cement, blast furnace cement, calcium aluminate cement, Type I Portland cement, Type IA Portland cement, Type II Portland cement, Type IIA Portland cement, Type III Portland cement, Type IIIA Portland cement, Type IV Portland cement, Type V Portland cement, hydraulic cement (e.g. white cement, grey cement, blended hydraulic cement, Type IS-Portland blast-furnace slag cement, Type IP and Type P-Portland-pozzolan cement, and Type I (SM)-slag modified Portland cement), Type GU-blended hydraulic cement, Type HE-high-early-strength cement, Type MS-moderate sulfate resistant cement, Type HS-high sulfate resistant cement, Type MH-moderate heat of hydration cement, Type LH-low heat of hydration cement, Type K expansive cement, Type O expansive cement, Type M expansive cement, Type S expansive cement, regulated set cement, very high early strength cement, high iron cement, and oil-well cement.

46. The repair mortar according to claim 1 wherein the cement binder comprises between about 20 vol. % to about 22 vol. % of the repair mortar, and a water to cement binder ratio of between about 0.2 to about 0.6, wherein the cement binder comprises one or more of a filler, a chemical admixture, and a moisture-retaining agent, and wherein the filler comprises one or more of sand, calcium carbonate, limestone, crushed stone, and gravel, and wherein the filler comprises between about 45 vol. % and about 55 vol. % of the repair mortar, wherein the chemical admixture comprises one or more of an air-entraining agent, retarding agent, accelerating agent, plasticizer, polymer, corrosion inhibitor, alkali-silica reactivity reduction agent, bonding agent, coloring agent, defoamer, odor-masking agent, and dry dispersing agent, wherein the chemical admixture comprises between about 0.03 vol. % and about 0.3 vol. % of the repair mortar, wherein the moisture-retaining agent comprises a co-polymer comprising one or more of hydroxypropyl methylcellulose (HPMC), hydroxyethyl methylcellulose (HEMC), welan and xanthan gums, and wherein the moisture-retaining agent comprises between about 0 vol. % and about 0.08 vol. % of the repair mortar.

47. The repair mortar of claim 42 wherein an aspect ratio of at least 95% of the cellulose fibrils is at least 50.

48. A method of preparing a repair mortar, the method comprising:
(a) mixing a cement binder and fine aggregate with water/chemical admixture to provide a workable cementitious material; mixing cellulose fibrils with water to provide a cellulose fibril slurry; and mixing the cellulose fibril slurry with the workable cementitious material; or
(b) mixing a cement binder and fine aggregate with water/chemical admixture to provide a workable cementitious material; and mixing cellulose fibrils with the workable cementitious material; or
(c) mixing a cement binder and fine aggregate with cellulose fibrils to uniformly disperse the cellulose fibrils throughout the repair mortar; and mixing the repair mortar and cellulose fibrils slurry to provide a repair mortar.

49. The method of claim 48 comprising applying the repair mortar according to claim 42 to the surface of the concrete substrate, further comprising pre-treating the surface of the concrete substrate.

50. A method of improving corrosion resistance of rebar in concrete material being repaired with repair mortar, the method comprising:
providing a cracked and/or damaged concrete material with rebar at least partly embedded therein;
mixing a cement binder and fine aggregate with cellulose fibrils to uniformly disperse the cellulose fibrils throughout the repair mortar;
mixing the cement binder, fine aggregate and cellulose fibrils with water/chemical admixture to provide a workable repair mortar; and
applying the workable repair mortar to the concrete material;
wherein the cellulose fibrils comprise about 0.1 vol. % of the repair mortar, wherein the surface area of the cellulose fibrils is between 60-100 m²/g, and wherein the cellulose fibrils have a width of between about 80 nm to about 500 nm and length of between about 100 μm to about 800 μm, wherein an aspect ratio of at least 95% of the cellulose fibrils is at least 50.
